(19) United States
(12) Patent Application Publication
(10) Pub. No.: US 2026/0238282 A1
(43) Pub. Date: Aug. 13, 2026

(54) METHOD AND APPARATUS FOR TRANSMITTING AND RECEIVING CHANNEL STATE INFORMATION

(71) Applicant: Samsung Electronics Co., Ltd., Suwon-si, Gyeonggi-do (KR)

(72) Inventors: Zhe CHEN, Beijing (CN); Feifei SUN, Beijing (CN); Sa ZHANG, Beijing (CN)

(21) Appl. No.: 19/156,202

(22) PCT Filed: Feb. 15, 2024
(86) PCT No.: PCT/KR2024/095160

§ 371 Date: Aug. 13, 2025

(30) Foreign Application Priority Data
Feb. 15, 2023 (CN) 202310163440.8
Jan. 23, 2024 (CN) 202410096606.3

(51) Int. Cl. H04B 7/06; H04W 24/10; H04W 76/28

(52) U.S. Cl. CPC H04B 7/0626; H04W 24/10; H04W 76/28

(57) ABSTRACT

The disclosure relates to a 5G or 6G communication system for supporting a higher data transmission rate. Provided are a method and an apparatus for transmitting and receiving channel state information (CSI). The method includes: receiving first configuration information for a CSI report; and in case that a first condition is satisfied, transmitting the CSI report based on the first configuration information. The first condition is related to one or more of: a time associated with cell discontinuous transmission (DTX), a time associated with cell discontinuous reception (DRX), or a time associated with subband full duplex (SBFD). The communication efficiency can be improved by the method.

### TECHNICAL FIELD

The disclosure relates to the technical field of wireless communication, and more specifically, relates to a method and an apparatus for transmitting and receiving channel state information (CSI).

### BACKGROUND ART

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The present disclosure may provide a method and an apparatus for transmitting and receiving CSI.

The technical objects to be achieved by various embodiments of the disclosure are not limited to the technical objects mentioned above, and other technical objects not mentioned may be considered by those skilled in the art from various embodiments of the disclosure to be described below.

### Solution to Problem

According to at least one embodiment of the disclosure, a method performed by a terminal in a wireless communication system is provided. The method includes: receiving first configuration information for a channel state information (CSI) report; and in case that a first condition is satisfied, transmitting the CSI report based on the first configuration information. The first condition is related to one or more of: a time associated with cell discontinuous transmission (DTX), a time associated with cell discontinuous reception (DRX), or a time associated with subband full duplex (SBFD).

In some implementations, for example, the first condition includes one or more of the following:
one or more of at least one channel state information-reference signal (CSI-RS) transmission occasion or at least one channel state information-interference measurement (CSI-IM) occasion in the time associated with the cell DTX are received;
one or more of at least one CSI-RS transmission occasion or at least one CSI-IM occasion in the time associated with the SBFD are received;
one or more of at least one CSI-RS transmission occasion or at least one CSI-IM occasion outside the time associated with the SBFD are received;
one or more of at least one CSI-RS transmission occasion or at least one CSI-IM occasion in the time associated with the cell DTX are received, where a frequency domain resource associated with at least one of the one or more of the at least one CSI-RS transmission occasion or the at least one CSI-IM occasion is located in frequency domain resources associated with the cell DTX;
one or more of at least one CSI-RS transmission occasion or at least one CSI-IM occasion in the time associated with the SBFD are received, where a frequency domain resource associated with at least one of the one or more of the at least one CSI-RS transmission occasion or the at least one CSI-IM occasion is located in a frequency domain resource for downlink among frequency domain resources associated with the SBFD; and
one or more of at least one CSI-RS transmission occasion or at least one CSI-IM occasion outside the time associated with the SBFD are received, where a frequency domain source associated with at least one of the one or more of the at least one CSI-RS transmission occasion or the at least one CSI-IM occasion is located in a frequency domain resource for downlink among frequency domain resources associated with the SBFD.

In some implementations, for example, the first condition includes one or more of the following:
the first configuration information includes a report quantity parameter that indicates at least one report quantity of the CSI report;
second configuration information associated with the cell DRX is received;
a transmission occasion of the CSI report is in the time associated with the cell DRX;
prior to receiving a first downlink control information (DCI) format for triggering the CSI report, a second DCI format for determining the time associated with the cell DRX is received;
the CSI report is one or more of a periodic CSI report, a semi-persistent CSI report, or an aperiodic CSI report;
the CSI report is carried by a physical uplink shared channel (PUSCH), where the PUSCH includes a transport block (TB);
the CSI report is carried by a PUSCH, where the PUSCH does not include a TB; or
the CSI report is carried by a physical uplink control channel (PUCCH).

In some implementations, for example, the first condition further includes that the at least one report quantity is one or more of the following combinations: a CSI-RS resource indicator (CRI), a rank indicator (RI), a precoding matrix indicator (PMI), and a channel quality indicator (CQI); the CRI, the RI, a layer indicator (LI), the PMI, and the CQI; the CRI, the RI, and a codebook parameter; the CRI, the RI, the codebook parameter, and the CQI; or the CRI, the RI, and the CQI.

According to at least one embodiment of the disclosure, a method performed by a terminal in a wireless communication system is provided. The method includes: determining a channel state information-reference signal (CSI-RS) resource set, where the CSI-RS resource set is associated with one or more resource pairs; and performing one or more of: determining a CSI parameter based on a frequency domain resource related to a CSI-RS; or transmitting a CSI report, where the CSI report includes the CSI parameter determined based on the frequency domain resource related to the CSI-RS. The frequency domain resource related to the CSI-RS is determined based on a frequency domain resource of a resource pair associated with the CSI report among the one or more resource pairs.

In some implementations, for example, the CSI-RS frequency domain resource is determined based on a union or an intersection of frequency domain resources of two resources of the resource pair associated with the CSI report among the one or more resource pairs.

In some implementations, for example, in case that subband full duplex (SBFD) is configured, the CSI-RS frequency domain resource is further determined based on a frequency domain resource for downlink among frequency domain resources associated with the SBFD.

In some implementations, for example, in case that the SBFD is configured: a CSI reference resource for the CSI report and/or a downlink control information (DCI) format for triggering the CSI report are/is within a time associated with the SBFD; or the CSI reference resource for the CSI report and/or the DCI format for triggering the CSI report are/is outside the time associated with the SBFD.

In some implementations, for example, the transmitting the CSI report includes transmitting the CSI report in case that a first condition is satisfied. The first condition includes one or more of:
first configuration information is received, where the first configuration information includes a report quantity parameter that indicates a report quantity of the CSI report;
one or more of at least one CSI-RS transmission occasion or at least one channel state information-interference measurement (CSI-IM) occasion in the time associated with the SBFD are received;
one or more of at least one CSI-RS transmission occasion or at least one CSI-IM occasion outside the time associated with the SBFD are received;
one or more of at least one CSI-RS transmission occasion or at least one CSI-IM occasion in the time associated with the SBFD are received, where a frequency domain resource associated with at least one of the one or more of the at least one CSI-RS transmission occasion or the at least one CSI-IM occasion is located in a frequency domain resource for downlink among frequency domain resources associated with the SBFD;
one or more of at least one CSI-RS transmission occasion or at least one CSI-IM occasion outside the time associated with the SBFD are received, where a frequency domain source associated with at least one of the one or more of the at least one CSI-RS transmission occasion or the at least one CSI-IM occasion is located in a frequency domain resource for downlink among frequency domain resources associated with the SBFD;
the CSI report is one or more of a periodic CSI report, a semi-persistent CSI report, or an aperiodic CSI report;
the CSI report is carried by a physical uplink shared channel (PUSCH), where the PUSCH includes a transport block (TB);
the CSI report is carried by a PUSCH, where the PUSCH does not include a TB; or
the CSI report is carried by a physical uplink control channel (PUCCH).

In some implementations, for example, the first condition further includes that the report quantity is one or more of the following combinations: a CSI-RS resource indicator (CRI), a rank indicator (RI), a precoding matrix indicator (PMI), and a channel quality indicator (CQI); the CRI, the RI, a layer indicator (LI), the PMI, and the CQI; the CRI, the RI and a single wideband indication; the CRI, the RI, the single wideband indication, and the CQI; or the CRI, the RI, and the CQI.

According to at least one embodiment of the disclosure, a method performed by a terminal in a wireless communication system is provided. The method includes: determining a channel state information-reference signal (CSI-RS) resource set, where the CSI-RS resource set is associated with one or more CSI-RS resources; and performing one or more of: determining a CSI parameter based on a frequency domain resource related to a CSI-RS; or transmitting a CSI report, where the CSI report includes the determined CSI parameter. In case that subband full duplex (SBFD) is configured, the frequency domain resource related to the CSI-RS is determined based on one or more of: a frequency domain resource of a CSI-RS resource associated with the CSI report among the one or more CSI-RS resources; or a frequency domain resource for downlink among frequency domain resources associated with the SBFD.

In some implementations, for example, a CSI reference resource for the CSI report is within a time associated with the SBFD; or the CSI reference resource for the CSI report is outside the time associated with the SBFD.

In some implementations, for example, the transmitting the CSI report includes transmitting the CSI report in case that a first condition is satisfied. The first condition includes one or more of the following:
first configuration information is received, where the first configuration information includes a report quantity parameter that indicates a report quantity of the CSI report;
one or more of at least one CSI-RS transmission occasion or at least one channel state information-interference measurement (CSI-IM) occasion in the time associated with the SBFD are received;
one or more of at least one CSI-RS transmission occasion or at least one CSI-IM occasion outside the time associated with the SBFD are received;
one or more of at least one CSI-RS transmission occasion or at least one CSI-IM occasion in the time associated with the SBFD are received, where a frequency domain resource associated with at least one of the one or more of the at least one CSI-RS transmission occasion or the at least one CSI-IM occasion is located in a frequency domain resource for downlink among frequency domain resources associated with the SBFD;
one or more of at least one CSI-RS transmission occasion or at least one CSI-IM occasion outside the time associated with the SBFD are received, where a frequency domain resource associated with at least one of the one or more of the at least one CSI-RS transmission occasion or the at least one CSI-IM occasion is located in a frequency domain resource for downlink among frequency domain resources associated with the SBFD;
the CSI report is one or more of a periodic CSI report, a semi-persistent CSI report, or an aperiodic CSI report;
the CSI report is carried by a physical uplink shared channel (PUSCH), where the PUSCH includes a transport block (TB);
the CSI report is carried by a PUSCH, where the PUSCH does not include a TB; or
the CSI report is carried by a physical uplink control channel (PUCCH).

In some implementations, for example, the first condition further includes that the report quantity is one or more of the following combinations: a CSI-RS resource indicator (CRI), a rank indicator (RI), a precoding matrix indicator (PMI), and a channel quality indicator (CQI); the CRI, the RI, a layer indicator (LI), the PMI, and the CQI; the CRI, the RI, and a single wideband indication; the CRI, the RI, the single wideband indication, and the CQI; or the CRI, the RI, and the CQI.

According to at least one embodiment of the disclosure, a method performed by a terminal in a wireless communication system is provided. The method includes: receiving first information, wherein the first information includes one or more of (i) N power parameters or (ii) M spatial domain parameters, wherein at least one of the N and M is an integer greater than 1; and determining one or more channel state information (CSI) parameters based on one or more of (i) the N power parameters or (ii) the M spatial domain parameters.

In some implementations, for example, the determining the CSI parameter based on one or more of (i) N power parameters or (ii) M spatial domain parameters includes one or more of:
determining the one or more CSI parameters based on the N power parameters;
determining the one or more CSI parameters based on the M spatial domain parameters;
determining the one or more CSI parameters based on the N power parameters and the M spatial domain parameters; or
determining the one or more CSI parameters based on multiple combinations of the power parameters and the spatial domain parameters, where each of the combinations includes a power parameter from the N power parameters and a spatial domain parameter from the M spatial domain parameters; or
determining the one or more CSI parameters based on N {power parameter, spatial domain parameter} pairs, the first information including the N {power parameter, spatial domain parameter} pairs, where N is equal to M.

In some implementations, for example, a number of the multiple combinations is N*M.

In some implementations, for example, the method further includes receiving second information that indicates one or more of:
a first subset of the N power parameters included in the first information;
a second subset of the M spatial domain parameters included in the first information;
a third subset of the multiple combinations of the power parameters and the spatial domain parameters included in the first information, where each of the combinations includes a power parameter from the N power parameters and a spatial domain parameter from the M spatial domain parameters; or
a fourth subset of the N {power parameter, spatial domain parameter} pairs included in the first information, where N is equal to M;
determining the one or more CSI parameters based on (i) the N power parameters and/or (ii) the M spatial domain parameters includes:
determining the one or more CSI parameters based on a subset indicated by the second information; or
determining the one or more CSI parameters based on power parameters and/or spatial domain parameters other than the subset indicated by the second information.

The indicated subset includes at least one of the first subset, the second subset, the third subset, and the fourth subset.

In some implementations, for example, the method further includes determining the number of CSI reports to be updated based on one or more of (i) the N power parameters or (ii) the M spatial domain parameters.

In some implementations, for example, the number of the CSI reports to be updated is further determined based on one or more of a number of CSI-RS resources associated with the CSI report or a number of the CSI-RS resource pairs.

In some implementations, for example, the first information is carried by downlink signaling for triggering or activating the CSI report associated with the CSI parameter; and/or the second information is carried by downlink signaling for triggering or activating the CSI report associated with the CSI parameter.

In some implementations, for example, the method further includes transmitting the CSI report including one or more CSI parameters in case that a first condition is satisfied. The first condition includes one or more of:
first configuration information is received, where the first configuration information includes a report quantity parameter that indicates a report quantity of the CSI report;
one or more of at least one CSI-RS transmission occasion or at least one channel state information-interference measurement (CSI-IM) occasion in the time associated with the subband full duplex (SBFD) are received;
one or more of at least one CSI-RS transmission occasion or at least one CSI-IM occasion outside the time associated with the SBFD are received;
one or more of at least one CSI-RS transmission occasion or at least one CSI-IM occasion in the time associated with the SBFD are received, where a frequency domain resource associated with at least one of the one or more of the at least one CSI-RS transmission occasion or the at least one CSI-IM occasion is located in a frequency domain resource for downlink among frequency domain resources associated with the SBFD;
one or more of at least one CSI-RS transmission occasion or at least one CSI-IM occasion outside the time associated with the SBFD are received, where a frequency domain source associated with at least one of the one or more of the at least one CSI-RS transmission occasion or the at least one CSI-IM occasion is located in a frequency domain resource for downlink among frequency domain resources associated with the SBFD;
the CSI report is one or more of a periodic CSI report, a semi-persistent CSI report, or an aperiodic CSI report;
the CSI report is carried by a physical uplink shared channel (PUSCH), where the PUSCH includes a transport block (TB);
the CSI report is carried by a PUSCH, where the PUSCH does not include a TB; or
the CSI report is carried by a physical uplink control channel (PUCCH).

In some implementations, for example, the first condition further includes the report quantity is one or more of the following combinations: a CSI-RS resource indicator (CRI), a rank indicator (RI), a precoding matrix indicator (PMI), and a channel quality indicator (CQI); the CRI, the RI, a layer indicator (LI), the PMI, and the CQI; the CRI, the RI, and a single wideband indication; the CRI, the RI, the single wideband indication, and the CQI; or the CRI, the RI and the CQI.

According to at least one embodiment of the disclosure, a terminal in a wireless communication system is provided. The terminal includes: a transceiver; and a controller, coupled to the transceiver and configured to perform one or more operations in above methods performed by the terminal.

According to at least one embodiment of the disclosure, a method performed by a base station in a wireless communication system is provided. The method includes: transmitting first configuration information for a channel state information (CSI) report to a terminal; and receiving the CSI report based on the first configuration information, where the CSI report is transmitted by the terminal in case that a first condition is satisfied. The first condition is related to one or more of: a time associated with cell discontinuous transmission (DTX), a time associated with cell discontinuous reception (DRX), or a time associated with subband full duplex (SBFD).

According to at least one embodiment of the disclosure, a base station in a wireless communication system is provided. The base station includes: a transceiver; and a controller, coupled to the transceiver and configured to execute one or more operations in above method performed by the base station.

According to at least one embodiment of the disclosure, a computer readable storage medium is further provided, on which one or more computer programs are stored. One or more operations of the above methods are implemented when the one or more computer programs are executed by one or more processors.

The above-described various embodiments of the disclosure are merely some of the preferred embodiments of the disclosure, and various embodiments reflecting the technical features of the disclosure may be derived and understood by those skilled in the art based on the following detailed description of the disclosure.

### Advantageous Effects of Invention

The present disclosure may provide a method and an apparatus for transmitting and receiving CSI.

The effects that can be achieved through the disclosure are not limited to the effects mentioned in the various embodiments, and other effects not mentioned will be clearly understood by those skilled in the art from the description below.

### BRIEF DESCRIPTION OF DRAWINGS

In order to illustrate the technical schemes of the embodiments of the disclosure more clearly, the drawings of the embodiments of the disclosure will be briefly introduced below. Apparently, the drawings described below only refer to some embodiments of the disclosure, and do not limit the disclosure. In the drawings:

FIG. 1 shows a schematic diagram of an example wireless network according to some embodiments of the disclosure;

FIG. 2A shows an example wireless transmitting path according to some embodiments of the disclosure;

FIG. 2B shows an example wireless receiving path according to some embodiments of the disclosure;

FIG. 3A shows example user equipment (UE) according to some embodiments of the disclosure;

FIG. 3B shows an example gNB according to some embodiments of the disclosure;

FIG. 4 shows a flow chart of a method performed by a terminal according to some embodiments of the disclosure;

FIG. 5 shows a flow chart of a method performed by a terminal according to some embodiments of the disclosure;

FIG. 6 shows a flow chart of a method performed by a terminal according to some embodiments of the disclosure;

FIG. 7 shows a flow chart of a method performed by a terminal according to some embodiments of the disclosure;

FIG. 8 shows a flow chart of a method performed by a base station according to some embodiments of the disclosure;

FIG. 9 shows a configuration of a terminal according to some embodiments of the disclosure;

FIG. 10 shows a configuration of a base station according to some embodiments of the disclosure.

### MODE FOR THE INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present invention. For example, unless otherwise defined, the technical terms or scientific terms used in the disclosure shall have the ordinary meaning understood by those with ordinary skills in the art to which the present invention belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies.

Hereinafter, the embodiments of the disclosure will be described in detail with reference to the accompanying drawings. It should be noted that the same reference numerals in different drawings will be used to refer to the same elements already described.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

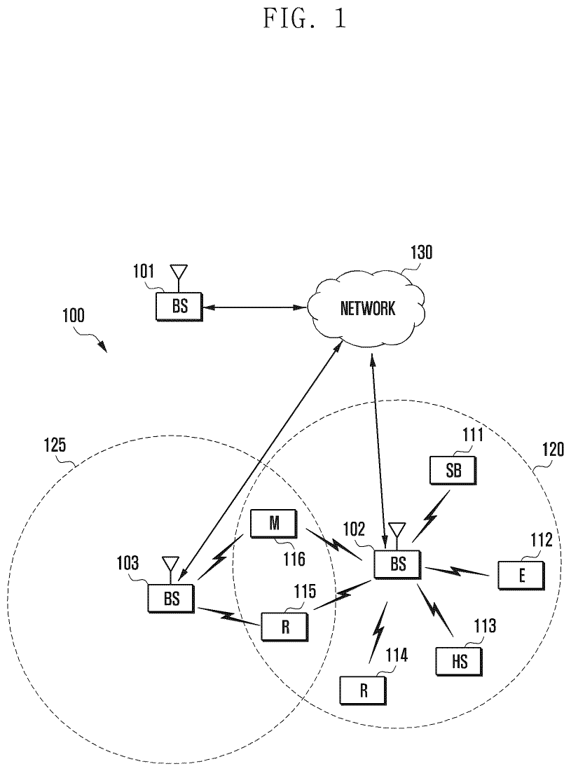

The following FIGS. 1-3B describe various embodiments implemented by using orthogonal frequency division multiplexing (OFDM) or orthogonal frequency division multiple access (OFDMA) communication technologies in wireless communication systems. The descriptions of FIGS. 1-3B do not mean physical or architectural implications for the manner in which different embodiments may be implemented. Different embodiments of the disclosure may be implemented in any suitably arranged communication systems.

FIG. 1 illustrates an example wireless network 100 according to some embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station (BS)” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some implementations, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some implementations, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

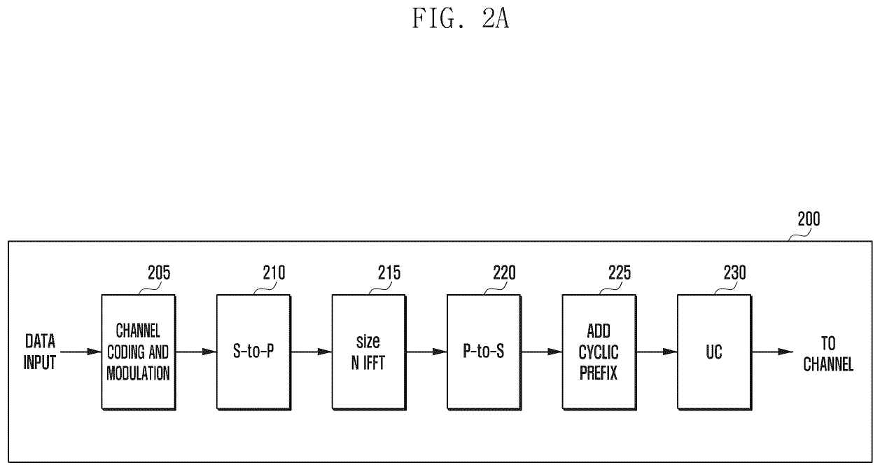

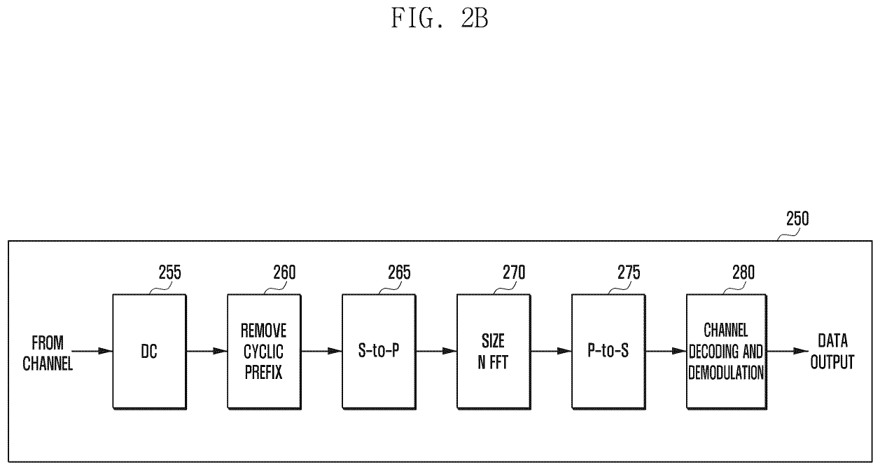

FIGS. 2A and 2B illustrate example wireless transmission and reception paths according to some embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some implementations, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

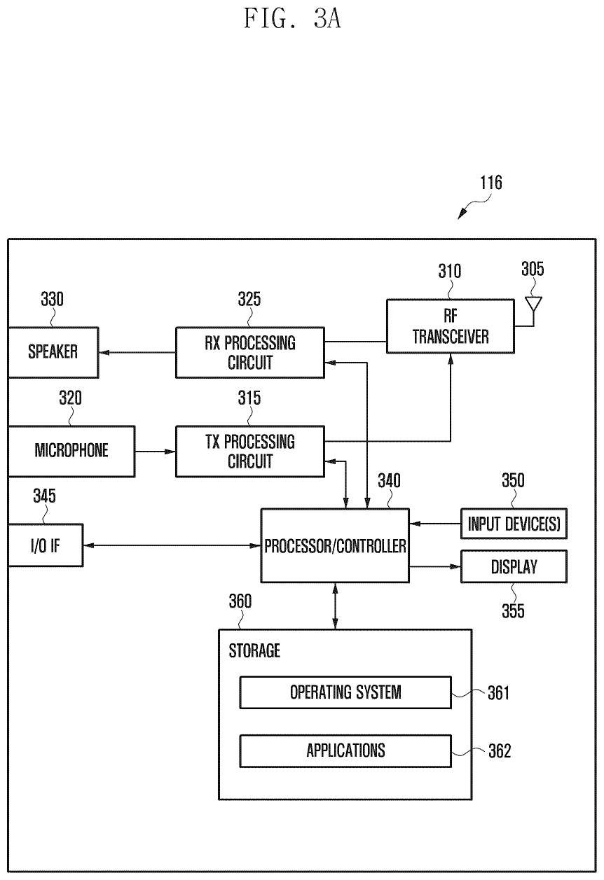

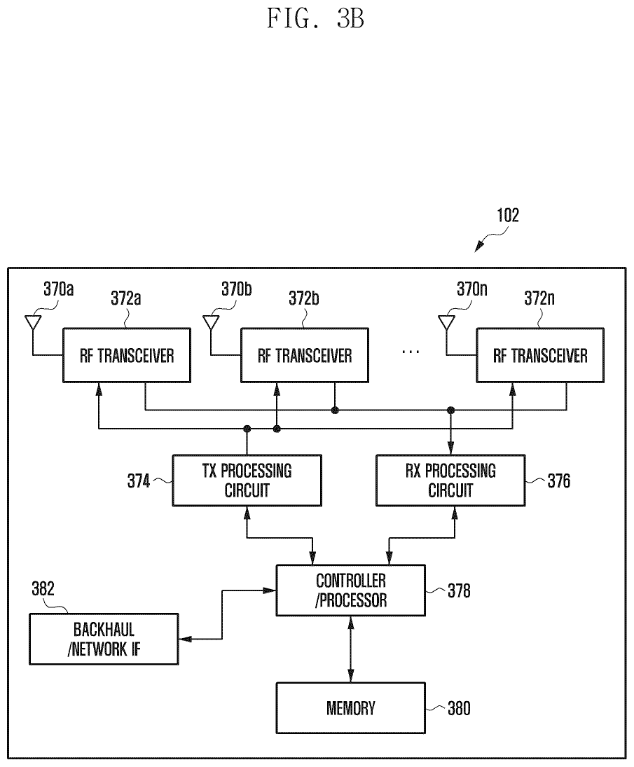

FIG. 3A illustrates an example UE 116 according to some embodiments of the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some implementations, the processor/controller 340 includes at least one microprocessor or microcontroller.

The processor/controller 340 is also capable of performing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some implementations, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

In some implementations, two or more UEs 116 may communicate directly using one or more sidelink channels (e.g., without using a base station as a medium for communication with each other). For example, the UE 116 may communicate using peer-to-peer (P2P) communication, device-to-device (D2D) communication, vehicle-to-everything (V2X) protocol (which, for example, may include vehicle-to-vehicle (V2V) protocol, vehicle-to-infrastructure (V2I) protocol, etc.), mesh network, etc. In this case, the UE 116 may perform scheduling operations, resource selection operations, and/or other operations performed by the base station as described elsewhere herein. For example, the base station may configure the UE 116 via downlink control information (DCI), radio resource control (RRC) signaling, medium access control-control element (MAC CE) or via system information (e.g., system information block (SIB)).

FIG. 3B illustrates an example gNB 102 according to some embodiments of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some implementations, the controller/processor 378 includes at least one microprocessor or microcontroller.

The controller/processor 378 is also capable of performing programs and other processes residing in the memory 380, such as a basic OS. The controller/processor 378 can also support channel quality measurement and reporting for systems with 2D antenna arrays as described in embodiments of the disclosure. In some implementations, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

It may be understood by those skilled in the part that the “terminal” and “terminal device” used herein not only include devices with wireless signal receivers having no transmission functions, but also include devices including both receiving and transmitting hardware which may perform bidirectional reception and transmission via a bidirectional communication link. The devices may include: cellular or other communication devices including a single line display or multi-line display; a personal communications service (PCS) capable of combining voice, data processing, fax and/or data communication functions; personal digital assistant (PDA), including a radio frequency receiver, a pager, Internet/Intranet visit device, a network browser, a notepad, a calendar, and/or a global positioning system (GPS) receiver; and conventional laptop and/or palm computers or other devices, including conventional laptop and/or palm computers or other devices equipped with/including RF receivers. The “terminal” and “terminal device” used herein may be portable and transportable, and can be provided in a vehicle (aviation, maritime and/or land), and are applicable to operate locally and/or operate in a distributed manner at any position of the earth and/or space. The “terminal” and “terminal device” used herein may also refer to a communication terminal, an Internet terminal, and a music/video player terminal, e.g., a PDA, a mobile Internet device (MID), and/or a mobile phone with a music/video playing function, or a smart TV, a set-top box, etc.

In some embodiments of the disclosure, various methods may be described with the communication between a base station and a terminal (UE) as an example. It should be understood that the embodiments of the disclosure may also applicable for a scenario of a side link communication between scheduling UE and scheduled UE. In this case, the scheduling UE may serve as a base station for operation, and may perform the method performed by the base station described according to the embodiments of the disclosure.

In describing a wireless communication system and in the disclosure described below, higher layer signaling or higher layer signal may be a signal transfer method for transferring information from a base station to a terminal via a downlink data channel of a physical layer or from a terminal to a base station via an uplink data channel of a physical layer. Examples of the signal transfer method may include signal transfer methods for transferring information via radio resource control (RRC) signaling, via packet data convergence protocol (PDCP) signaling, or via a control element (CE) of medium access control (MAC).

In the following description of the disclosure, the higher layer signaling may be signaling corresponding to at least one or a combination of one or more of the following signaling:
MIB (master information block)
SIB (system information block) or SIB X (X=1, 2, . . . )
RRC signaling
MAC CE

Physical layer (Layer 1 (L1)) signaling may be signaling corresponding to at least one or a combination of one or more of the following signaling:
PDCCH (physical downlink control channel)
DCI (downlink control information)
UE specific DCI
Group common DCI
Common DCI
Scheduling DCI (e.g., the DCI for scheduling downlink or uplink data)
Non-scheduling DCI (e.g., the DCI except for the DCI for scheduling the downlink or uplink data)
PUCCH (physical uplink control channel)
UCI (uplink control information)

In embodiments of the disclosure, uplink control signaling may include physical layer signaling and/or higher layer signaling. As described above, the physical layer signaling may include UCI and/or PUCCH, and the higher layer signaling may include RRC signaling and/or MAC CE.

In embodiments of the disclosure, downlink control signaling may include physical layer signaling and/or higher layer signaling. As mentioned above, the physical layer signaling may include one or more of PDCCH, DCI, UE-specific DCI, group common DCI, common DCI, scheduling DCI (e.g., DCI for scheduling downlink or uplink data), and non-scheduling DCI, and the higher layer signaling may include one or more of MIB, SIB or SIB X (X=1, 2, . . . ), RRC signaling or MAC CE. Therefore, “configuring or indicating X through downlink control signaling” will be understood as configuring or indicating X through physical layer signaling, or configuring or indicating X through higher layer signaling, or configuring or indicating X through a combination of higher layer signaling and physical layer signaling.

It should be noted that unless the context clearly indicates otherwise, all or one or more of methods, steps or operations described in the embodiments of the disclosure may be indicated via protocol specification and/or higher layer signaling configuration and/or dynamic signaling. The dynamic signaling may be a PDCCH, and/or DCI, and/or a DCI format. For example, a semi-persistent scheduling (SPS) physical downlink shared channel (/PDCCH) and/or configured grant (CG) physical uplink shared channel (PUSCH) may be dynamically indicated in activated DCI/DCI format/PDCCH thereof. All or one or more of the described methods, steps and operations may be optional. For example, if a certain parameter (e.g., parameter X) is configured, the UE performs a certain method (e.g., method A). Otherwise (if the parameter, for example, parameter X, is not configured), the UE performs another method (e.g., method B). Unless otherwise specified, the parameters in the embodiments of the disclosure may be higher layer parameters. For example, the higher layer parameters may be parameters configured or indicated via higher layer signaling (e.g., RRC signaling).

It should be noted that various method described in the disclosure may be combined in any order. In one combination, one method may be performed one or more times.

It should be noted that various steps in the method of the disclosure may be implemented in any order.

It should be noted that, in embodiments of the disclosure, “performing a predefined method (or step) if a predefined condition is satisfied” and “not performing the predefined method (or step) if the predefined conditions is not satisfied” may be used interchangeably. “Not performing a predefined method (or step) if a predefined condition is satisfied” and “performing the predefined methods (or step) if the predefined condition is not satisfied” may be used interchangeably.

In the following, various embodiments of the disclosure will be described in detail with reference to accompanying drawings.

In wireless communication systems, duplex mode may be used to enhance coverage or reduce latency. For example, duplex mode may include subband full duplex (SBFD) mode, which may also be called a subband non-overlapping full duplex mode. For example, the subband non-overlapping full duplex mode may be employed at a TDD band (e.g., unpaired spectrum). The subband non-overlapping full duplex mode may refer to dividing a bandwidth (e.g., carrier bandwidth) of a communication mode (e.g., a base station) into more than one subband (e.g., the subbands does not overlap with each other), and simultaneously performing uplink and downlink communication in different subbands. The base station may flexibly change an uplink/downlink ratio of the subbands with the subband non-overlapping duplex technology, for example, allocate more than one subband as all uplink (or all downlink), or increase/decrease the uplink/downlink ratio of the subbands. Therefore, the opportunities of uplink transmission/downlink reception of the terminal device (e.g., UE) at a time domain are increased, thereby enhancing the coverage capacity of the terminal device in the system and/or reducing the transmission delay of the terminal device.

Further, in some cases, the base station may operate in a mode related to energy/power saving. For example, the base station may operate in a cell/network DRX mode and/or a cell/network DTX mode. For example, in active period(s) of cell/network DTX and/or active period(s) of cell/network DRX, the base station or cell may be on, or awake, or in an active state. In non-active period(s) of cell/network DTX and/or non-active period(s) of cell/network DRX, the base station or cell (or network) is off, sleeping, or in an inactive state. The power consumption of the base station can be reduced in such a way.

In communication systems, the UE may receive a reference signal, performs channel measurement based on the reference signal, and estimates a channel state based on the channel measurement, so as to obtain CSI. The UE may determine (e.g., compute or derive) a CSI parameter, and transmit a CSI report including the CSI parameter. In embodiments of the disclosure, the CSI-RS is used as an example for describing the reference signal. However, the embodiments of the disclosure are not limited thereto, the reference signal for measurement may also be other types of reference signals, such as a demodulation reference signal (DM-RS), or a phase tracking reference signal (PT-RS). The CSI may include one or more of: a channel quality indicator (CQI), a precoding matrix indicator (PMI), a CSI-RS resource indicator (CRI), a synchronous signal (SS)/physical broadcast channel (PBCH) block resource indicator (SSBRI), a layer indicator (L1), a rank indicator (RI), reference signal receiving power (RSRP), or a signal to interference plus noise power ratio (SINR).

At present, a method for determining the CSI (it may also be called CSI parameter in embodiments of the disclosure) or reporting the CSI parameter does not consider the impact caused by the subband non-overlapping duplex mode and/or the network energy-saving mode, which may lead to the decrease of accuracy in CSI parameter determination/feedback by the UE.

In order to at least solve the above problem, the embodiments of the disclosure provide a method and apparatus for a CSI report, such that the UE may accurately determine or feed back the CSI parameter in case that the base station operates in the subband non-overlapping duplex, thereby improving the performance of the communication system.

In the wireless communication system (e.g., 5G), in order to enhance flexibility of scheduling, one implementation mode is to flexibly (dynamically) change power parameters and/or spatial domain parameters for a network device, thus making the network device adapt to demands of a user at different time.

However, the UE generally calculates or reports the CSI parameter semi-statically according to one power parameter and one spatial domain parameter at present, which cannot satisfy the demands of flexible adjustment at a base station side.

In order to at least solve the problem above, the embodiments of the disclosure provide a method and apparatus for CSI report, such that the UE may calculate or report a CSI parameter according to combinations of one or more of power parameters and/or spatial domain parameters. Therefore, the base station may flexibly select power parameter(s) and/or spatial domain parameter(s) for downlink transmission in the combinations, so as to improve the scheduling flexibility of the base station.

According to some embodiments of the disclosure, the UE may determine a CSI report, and/or transmit a CSI report using one or more of the following Methods I to V.

### Method I

In Method I, if a first predefined condition is satisfied, the UE may transmit (a) CSI report. The first predefined condition may include at least one of the following:
The UE receives (or has received) at least one CSI-RS transmission occasion (e.g., at least one CSI-RS transmission occasion for channel measurement, and/or at least one CSI-RS transmission occasion for interference measurement) and/or at least one channel state information-interference measurement (CSI-IM) occasion no later than a CSI reference resource.
The UE receives (or has received) at least one CSI-RS transmission occasion (e.g., at least one CSI-RS transmission occasion for channel measurement, and/or at least one CSI-RS transmission occasion for interference measurement) and/or at least one CSI-IM occasion in DRX active time (e.g., DRX active time of the UE).
The UE receives (or has received) at least one CSI-RS transmission occasion (e.g., at least one CSI-RS transmission occasion for channel measurement, and/or at least one CSI-RS transmission occasion for interference measurement) and/or at least one CSI-IM occasion in a first time (e.g., active period(s) of cell DTX).
The UE receives (or has received) at least one CSI-RS transmission occasion (e.g., at least one CSI-RS transmission occasion for channel measurement and/or at least one CSI-RS transmission occasion for interference measurement) and/or at least one CSI-IM occasion in a third time (e.g., SBFD symbols) or a fourth time (e.g., non-SBFD symbols).
The UE receives (or has received) at least one CSI-RS transmission occasion (e.g., at least one CSI-RS transmission occasion for channel measurement, and/or at least one CSI-RS transmission occasion for interference measurement) and/or at least one CSI-IM occasion, and a frequency domain resource (e.g., a frequency domain resource of the associated CSI-RS) associated with/occupied by (at least one or all of) the at least one CSI-RS transmission occasion and/or the at least one CSI-IM occasion is less than or equal to a second frequency domain resource or a third frequency domain resource (examples about the second frequency domain resource or the third frequency domain resource may refer to the later description).
The UE receives (or has received) at least one CSI-RS transmission occasion (e.g., at least one CSI-RS transmission occasion for channel measurement, and/or at least one CSI-RS transmission occasion for interference measurement) and/or at least one CSI-IM occasion in the third time (e.g., SBFD symbols) or the fourth time (e.g., non-SBFD symbols), and a frequency domain resource (e.g., a frequency domain resource of the associated CSI-RS) associated with/occupied by (at least one or all of) the at least one CSI-RS transmission occasion and the at least one CSI-IM occasion is less than or equal to a second frequency domain resource or a third frequency domain resource (examples about the second frequency domain resource or the third frequency domain resource may refer to the later description).

Optionally, when the first predefined condition is not satisfied, the UE may discard/drop the (corresponding) CSI report.

Optionally, in Method I, the UE may receive CSI report configuration information (which may also be called a CSI report configuration parameter in the embodiments of the disclosure, for example, CSI-ReportConfig). For example, the CSI report configuration information may include one or more of: codebook configuration including codebook subset restriction; time domain behavior; frequency granularity for CQI and PMI; measurement restriction configurations; or CSI-related quantities to be reported by the UE (report quantities of the CSI report), e.g., report quantity parameters described below.

In some implementations, if the UE receives (or has received) at least one CSI-RS transmission occasion (e.g., at least one CSI-RS transmission occasion for channel measurement, and/or at least one CSI-RS transmission occasion for interference measurement) and/or at least one CSI-IM occasion, the UE transmits (a) CSI report. The at least one CSI-RS transmission occasion and/or the at least one CSI-IM occasion has at least one of the following characteristics:
The at least one CSI-RS transmission occasion and/or the at least one CSI-IM occasion are/is no later than a CSI reference resource.
The at least one CSI-RS transmission occasion and/or the at least one CSI-IM occasion are/is in the DRX active time.
The at least one CSI-RS transmission occasion and/or the at least one CSI-IM occasion are/is in the first time (e.g., active period(s) of cell DTX).
The at least one CSI-RS transmission occasion and/or the at least one CSI-IM occasion are/is in the third time (e.g., SBFD symbols) or the fourth time (non-SBFD symbols).
A frequency domain resource (e.g., a frequency domain resource of the associated CSI-RS resource) associated with/occupied by (at least one or all of) the at least one CSI-RS transmission occasion and/or the at least one CSI-IM occasion is less than or equal to the second frequency domain resource or the third frequency domain resource (examples about the second frequency domain resource or the third frequency domain resource may refer to the later description).
The at least one CSI-RS transmission occasion and/or the at least one CSI-IM occasion are/is in the third time (e.g., SBFD symbols) or the fourth time (e.g., non-SBFD symbols), and a frequency domain resource (e.g., a frequency domain resource of the associated CSI-RS resource) associated with/occupied by (at least one or all of) the at least one CSI-RS transmission occasion and the at least one CSI-IM occasion is less than or equal to the second frequency domain resource or the third frequency domain resource (examples about the second frequency domain resource or the third frequency domain resource may refer to the later description).

Optionally, if the UE does not receive at least one CSI-RS transmission occasion (e.g., at least one CSI-RS transmission occasion for channel measurement, and/or at least one CSI-RS transmission occasion for interference measurement) and/or at least one CSI-IM occasion, the UE may discard/drop the (corresponding) CSI report.

Optionally, when a CSI-RS resource set (for channel measurement) corresponding to/associated with the CSI report is configured with two resource sets and one or more (e.g., N) resource pairs (which may also be called CSI-RS resource pair in the embodiments of the disclosure). When the first predefined condition is satisfied, the UE may transmit (a) CSI report. The first predefined condition (may be understood as) may include at least one of the following:
The UE receives (or has received) at least one CSI-RS transmission occasion and/or CSI-IM occasion of at least one (or each) CSI-RS resource of a resource pair no later than a CSI reference source.
The UE receives (or has received) at least one CSI-RS transmission occasion and/or CSI-IM occasion of at least one (or each) CSI-RS resource of a resource pair in the DRX active time.
The UE receives (or has received) at least one CSI-RS transmission occasion and/or CSI-IM occasion of at least one (or each) CSI-RS resource of a resource pair in the first time (e.g., active period(s) of cell DTX).
The UE receives (or has received) at least one CSI-RS transmission occasion and/or CSI-IM occasion of at least one (or each) CSI-RS resource of a resource pair in the third time (e.g., SBFD symbols) or the fourth time (e.g., non-SBFD symbols).
The UE receives (or has received) at least one CSI-RS transmission occasion and/or CSI-IM occasion of at least one (or each) CSI-RS resource of a resource pair, and a frequency domain resource (e.g., a frequency domain resource of the associated CSI-RS resource) associated with/occupied by (at least one or all of) the at least one CSI-RS transmission occasion and/or the at least one CSI-IM occasion is less than or equal to the second frequency domain resource or the third frequency domain resource (examples about the second frequency domain resource or the third frequency domain resource may refer to the later description).
The UE receives (or has received) at least one CSI-RS transmission occasion and/or CSI-IM occasion of at least one (or each) CSI-RS resource of a resource pair in the third time (e.g., SBFD symbols) or the fourth time (e.g., non-SBFD symbols), and a frequency domain resource (e.g., a frequency domain resource of the associated CSI-RS resource) associated with/occupied by (at least one or all of) the at least one CSI-RS transmission occasion and the at least one CSI-IM occasion is less than or equal to the second frequency domain resource or the third frequency domain resource (examples about the second frequency domain resource or the third frequency domain resource may refer to the later description).

For the CSI-RS resource set configured with two resource groups and one or more resource pairs, the two resource groups include a first resource group (Group 1) and a second resource group (Group 2), and each of the resource pairs consists of one resource from Group 1 and one resource from Group 2.

Optionally, when the first predefined condition is not satisfied, the UE may discard/drop the (corresponding) CSI report.

Optionally, when the CSI-RS resource set (for channel measurement) corresponding to/associated with the CSI report is configured with two resource groups and one or more (e.g., N) resource pairs, and the UE receives (or, has received) at least one CSI-RS transmission occasion and/or CSI-IM occasion of at least one (or each) CSI-RS resource of a resource pair, the UE may transmit (a) CSI report. The at least one CSI-RS transmission occasion and/or CSI-IM occasion of at least one (or each) CSI-RS resource may have at least one of the following characteristics:
The at least one CSI-RS transmission occasion and/or CSI-IM occasion of at least one (or each) CSI-RS resource are/is no later than the CSI reference resource.
The at least one CSI-RS transmission occasion and/or CSI-IM occasion of at least one (or each) CSI-RS resource are/is in the DRX active time.
The at least one CSI-RS transmission occasion and/or CSI-IM occasion of at least one (or each) CSI-RS resource are/is in the first time (e.g., active period(s) of cell DTX).
The at least one CSI-RS transmission occasion and/or CSI-IM occasion of at least one (or each) CSI-RS resource are/is in the third time (e.g., SBFD symbols) or the fourth time (non-SBFD symbols).
A frequency domain resource (e.g., a frequency domain resource of the associated CSI-RS resource) associated with/occupied by (at least one or all of) the at least one CSI-RS transmission occasion and/or CSI-IM occasion of at least one (or each) CSI-RS resource is less than or equal to the second frequency domain resource or the third frequency domain resource (examples about the second frequency domain resource or the third frequency domain resource may refer to the later description).
The at least one CSI-RS transmission occasion and/or CSI-IM occasion of at least one (or each) CSI-RS resource is in the third time (e.g., SBFD symbols) or the fourth time (e.g., non-SBFD symbols), and a frequency domain resource (e.g., a frequency domain resource of the associated CSI-RS resource) associated with/occupied by (at least one or all of) the at least one CSI-RS transmission occasion and/or CSI-IM occasion of at least one (or each) CSI-RS resource is less than or equal to the second frequency domain resource or the third frequency domain resource (examples about the second frequency domain resource or the third frequency domain resource may refer to the later description).

Optionally, when the CSI-RS resource set (for channel measurement) corresponding to/associated with the CSI report is configured with two resource groups and one or more (e.g., N) resource pairs, and the UE does not receive at least one CSI-RS transmission occasion and/or CSI-IM occasion of at least one (or each) CSI-RS resource of a resource pair, the UE may discard/drop the (corresponding) CSI report.

Examples of the first time according to some embodiments of the disclosure are described below.

In some implementations, the first time may be associated with the cell/network DTX/DRX. For example, when the cell/network DTX/DRX is configured, the first time may be determined.

Optionally, the UE may receive configuration information (e.g., cell/network DTX/DRX configuration information, or is used for configuring the cell/network DTX/DRX) and/or an indication (e.g., a cell/network DTX/DRX indication, for example, which is used for indicating cell/network DTX/DRX). Optionally, the first time may be associated with the configuration information and/or indication. Optionally, the first time may be determined according to the configuration information and/or indication. Optionally, the UE can determine (a time domain position of) the first time according to the configuration information and/or indication.

Optionally, when the cell/network DTX/DRX configuration information is configured, and the first predefined condition is satisfied, the UE may transmit (a) CSI report.

Optionally, when the cell/network DTX/DRX configuration information is configured, and the first predefined condition is not satisfied, the UE may discard/drop (a) CSI report.

Optionally, the first time may be cell/network active period. For example, the first time may be active period(s) of cell/network DTX and/or active period(s) of cell/network DRX.

Optionally, the first time may be a time domain resource for cell (network) energy/power saving.

Optionally, in the first time, the cell (or network) may be on (or in an on mode, or in an on state). Optionally, in the first time, the cell (or network) may wake-up (or in a wake-up mode, or in a wake-up state). Optionally, in the first time, the cell (or network) may be active (or in an active mode, or in an active state).

Optionally, in the first time (e.g., active period(s) of cell/network DTX), the cell (or network) may transmit a (particular) downlink channel and/or signal (or, the UE receives a (particular) downlink channel and/or signal). The particular downlink channel and/or signal may refer to at least one of the following:
CSI-RS;
DM-RS;
PDSCH;
PUCCH;
Synchronous signal (SS)/physical broadcast channel (PBCH) block (SSB).

Optionally, in the first time (e.g., cell/network DRX active period), the cell (or network) may receive a (particular) uplink channel and/or signal (or, the UE transmits a (particular) uplink channel and/or signal). The particular uplink channel and/or signal may be at least one of the following:
Sensing reference signal (sounding reference signal, SRS);
DM-RS;
Physical random-access channel (PRACH);
PUSCH;
PUCCH.

Optionally, the first time may refer to a time that is not the second time, or a time other than the second time. For example, the first time may be a time outside the second time.

Examples of the second time according to some embodiments of the disclosure are described below.

In some implementations, the second time may be a time associated with the cell/network DTX/DRX. For example, when the cell/network DTX/DRX is configured, the second time may be determined.

Optionally, the second time may be a time other than first time, or a time that is not the first time. For example, the second time may be a time outside the first time.

Optionally, the UE may receive configuration information (e.g., cell/network DTX/DRX configuration information) and/or indication (e.g., cell/network DTX/DRX indication). Optionally, the second time may be associated with the configuration information and/or indication. Optionally, the second time may be determined according to the configuration information and/or indication. Optionally, the UE may determine (a time domain position of) the second time according to the configuration information and/or indication.

Optionally, when the cell/network DTX/DRX configuration information is configured, and the first predefined condition is satisfied, the UE may transmit (a) CSI report.

Optionally, when the cell/network DTX/DRX configuration information is configured, and the first predefined condition is not satisfied, the UE may discard/drop (a) CSI report.

Optionally, the second time may be non-active period(s) of cell/network. For example, the second time may be non-active period(s) of cell/network DTX and/or non-active period(s) of cell/network DRX.

Optionally, the second time may be a time domain resource for cell (network) energy/power saving.

Optionally, in the second time, the cell (or network) may be off (or in an off mode, or in an off state). Optionally, in the second time, the cell (or network) may be sleeping (or in a sleep mode, or in a sleep state). Optionally, in the second time, the cell (or network) may be inactive (or in an inactive mode, or in an inactive state).

Optionally, in the second time (e.g., non-active period(s) of cell/network DTX), the cell (or network) may not transmit a (particular) downlink channel and/or signal (or, the UE does not receive a (particular) downlink channel and/or signal). The particular downlink channel and/or signal may refer to at least one of the following:
CSI-RS;
DM-RS;
PDSCH;
PUCCH;
SSB.

Optionally, in the second time (e.g., non-active period(s) of cell/network DRX), the cell (or network) may not receive a (particular) uplink channel and/or signal (or, the UE does not transmit a (particular) uplink channel and/or signal). The particular uplink channel and/or signal may refer to at least one of the following:
SRS;
DM-RS;
PRACH;
PUSCH;
PUCCH.

Examples of the third time according to some embodiments of the disclosure are described below.

In some implementations, the third time may be associated with SBFD. For example, the third time may be a time resource to which the SBFD is applied (e.g., SBFD symbols). Optionally, the third time may be a time resource for SBFD operations (e.g., SBFD symbols).

Optionally, the third time may be determined by (SBFD) configuration information. Optionally, the third time is provided/indicated by the (SBFD) configuration information. Optionally, information related to a guard band is determined according to the (SBFD) configuration information. Optionally, information related to a guard band is provided by the (SBFD) configuration information.

Optionally, the UE may receive the (SBFD) configuration information. Optionally, the (SBFD) configuration information provides a (corresponding) frequency domain resource for uplink transmission (which may be called a first frequency domain resource in the embodiments of the disclosure). For example, the (SBFD) configuration information may indicate the first frequency domain resource for uplink transmission in the third time. Optionally, the UE may perform uplink transmission (or transmit an uplink signal or channel) on the first frequency domain resource in the third time (and/or in a downlink time unit and/or flexible time unit (configured by common information)). Optionally, the (SBFD) configuration information provides a (corresponding) frequency domain resource for downlink transmission (which may be called a second frequency domain resource in the embodiments of the disclosure). For example, the (SBFD) configuration information may indicate the second frequency domain resource for downlink transmission in the third time. Optionally, the second frequency domain resource may refer to the frequency domain resource other than the first frequency domain resource (and/or a guard band). Optionally, the UE may perform downlink reception (or receive a downlink signal or channel) on the second frequency domain resource in the third time (and/or in a downlink time unit and/or flexible time unit (configured by common information)). In the embodiments of the disclosure, the time unit, for example, is a symbol or a slot. Optionally, the common information may refer to common TDD configuration information (e.g., tdd-UL-DL-ConfigurationCommon; for another example, tdd-UL-DL-ConfigurationDedicated).

Optionally, the UE may receive the (SBFD) configuration information. Optionally, the (SBFD) configuration information provides a (corresponding) frequency domain resource for downlink transmission (which may be called a third frequency domain resource in the embodiments of the disclosure). For example, the (SBFD) configuration information may indicate the third frequency domain resource for downlink transmission in the third time (e.g., SBFD symbols). Optionally, the UE may perform downlink reception (or receive a downlink signal or channel) on the third frequency domain resource in the third time (and/or at an uplink time unit and/or flexible time unit (configured by common information)). Optionally, the (SBFD) configuration information provides a (corresponding) fourth frequency domain resource for uplink transmission. For example, the (SBFD) configuration information may indicate the fourth frequency domain resource for uplink transmission in the third time (e.g., SBFD symbols). Optionally, the fourth frequency domain resource may refer to the frequency domain resources other than the third frequency domain resource (and/or a guard band). For example, the fourth frequency domain resource may refer to the frequency domain resources other than the frequency domain resource for downlink transmission in the third time (e.g., SBFD symbols). Optionally, the UE may perform uplink transmission (or transmit an uplink signal or channel) on the fourth frequency domain resource in the third time (and/or at an uplink time unit and/or flexible time unit (configured by common information)). Herein, the time unit, for example, is a symbol or a slot. Optionally, the common information may refer to common TDD configuration information (for example, tdd-UL-DL-ConfigurationCommon; for another example, tdd-UL-DL-ConfigurationDedicated).

Optionally, the UE may also receive configuration information (for indicating a CSI-RS measurement purpose or indicating a CSI-RS measurement time period corresponding to the CSI report) (of the CSI report). Optionally, when the configuration information indicates that the CSI report is for the third time (or, the CSI-RS measurement corresponding to the CSI report is for the third time; or the CSI report is for SBFD operations; or when the configuration information is configured), the UE may perform the operations above (according to the third time) (e.g., an operation that the UE may report the CSI report when there is at least one measurement CSI-RS resource transmission occasion within the third time, otherwise, the UE discards/drops the CSI report). Optionally, when the UE does not receive the configuration information (or when the configuration information is not configured), the UE may perform a corresponding operation according to the fourth time (e.g., non-SBFD symbols) (rather than the third time).

Examples of the fourth time according to some embodiments of the disclosure are described below.

In some implementations, the fourth time may be a time when the SBFD is not applied. Optionally, the fourth time may refer to a time that is not the third time, or a time other than the third time. For example, the fourth time may be a time outside the third time.

Optionally, the UE may also receive configuration information (for indicating a CSI-RS measurement purpose or indicating a CSI-RS measurement time period corresponding to the CSI report) (of the CSI report). Optionally, when the configuration information indicates that the CSI report is for the fourth time (or, the CSI-RS measurement corresponding to the CSI report is for the fourth time; or the CSI report is for non-SBFD operations/traditional operations; or when the configuration information is configured), the UE performs a corresponding operation (according to the fourth time) (e.g., an operation that the UE may report the CSI report when there is at least one measurement CSI-RS resource transmission occasion within the fourth time, otherwise, the UE discards/drops the CSI report). Optionally, when the UE does not receive the configuration information (or when the configuration information is not configured), the UE may perform a corresponding operation according to the third time (e.g.,) (rather than the fourth time).

In embodiments of the disclosure, the terms “time resource” may be used interchangeably with “time” or “time period”. The time resource may include one or more symbols (OFDM symbols), one or more subframes, one or more frames, one or more slots, or one or more mini-slots.

For example, the first time may be called a first time resource, or a first time period.

For example, the second time may be called a second time resource, or a second time period.

For example, the third time may be called a third time resource, or a third time period.

For example, the fourth time may be called a fourth time resource, or a fourth time period.

In some implementations, the CSI reference resource may refer to a reference source in time domain and/or frequency domain of the CSI report. For example, the CSI reference resource may be used to determine a resource position for CSI measurement (for example, a time domain resource position; for another example, the latest time domain resource position). In a general condition, the time domain resource position for CSI measurement may need to precede the time domain resource of the CSI reference resource. In some examples, in the frequency domain, the CSI reference resource is defined by a downlink frequency domain resource (e.g., the group of downlink physical resource blocks) corresponding to a band to which the derived CSI relates. In the time domain, the CSI reference resource for the CSI report in an uplink slot n′ may be defined by a single downlink slot n−n_{CSI_ref}, where └ ┘″ denotes a rounding down operation. Herein, μ_{DL} and μ_{UL} are subcarrier spacing configurations for DL and UL, respectively, and n_{CSI_ref} denotes a CSI slot reference, a value of which depends on the type of the CSI report.

According to Method I of the embodiments of the disclosure, whether the UE transmits or discards/drops the CSI report is defined under a particular time domain condition (e.g., a time domain condition related to the SBFD). Therefore, a situation that the UE reports an inaccurate CSI in case of not satisfying the condition is avoided, thus improving the reliability of the communication system.

### Method II

In Method II, if a second predefined condition is satisfied, the UE may report a CSI report. The second predefined condition may include at least one of the following:
The UE receives a CSI report configuration parameter, and the CSI report configuration parameter corresponds to a particular report quantity.
The UE is configured with cell/network DRX configuration information.
The CSI report is within a first time (e.g., cell DRX active period).
The UE receives (indication) information for determining the first time prior to receiving information for triggering a CSI report.
The CSI report is at least one of a periodic CSI report, a semi-persistent CSI report, or an aperiodic CSI report.
The CSI report is carried by a PUSCH, and the PUSCH includes, or does not include, a TB.
The CSI report is carried by a PUCCH.
The CSI report is a periodic L1-RSRP report.
The CSI report is a periodic CSI report other than L1-RSRP.

Optionally, when the second predefined condition is not satisfied, the UE may discard/drop the (corresponding) CSI report.

In Method II, the UE may receive a CSI report configuration parameter (CSI-ReportConfig). Optionally, the report quantity of the CSI report configuration parameter includes (or corresponds to) a particular report quantity. Optionally, the particular report quantity may indicate at least one of the following combinations: CRI, RI, PMI, and CQI; CRI, RI, LI, PMI, and CQI; CRI, RI, and i1 (codebook parameter); CRI, RI, i1, and CQI; CRI, RI, and CQI; CRI, and RSRP; SSBRI, and RSRP; none.

Optionally, the report quantity of the CSI report (configuration parameter) being CRI, RI, PMI and CQI may refer to that the report quantity parameter of the CSI report (reportQuantity, or reportQuantity in the CSI-ReportConfig) is set/configured as ‘cri-RI-PMI-CQI’ (via RRC signaling).

Optionally, the report quantity of the CSI report (configuration parameter) being CRI, RI, LI, PMI and CQI may refer to that the report quantity parameter of the CSI report (reportQuantity, or reportQuantity in the CSI-ReportConfig) is set/configured as ‘cri-RI-LI-PMI-CQI’ (via RRC signaling).

Optionally, the report quantity of the CSI report (configuration parameter) being CRI, RI and i1 may refer to that the report quantity parameter of the CSI report (reportQuantity, or reportQuantity in the CSI-ReportConfig) is set/configured as ‘cri-RI-i1’ (via RRC signaling).

Optionally, the report quantity of the CSI report (configuration parameter) being CRI, RI, i1 and CQI may refer to that the report quantity parameter of the CSI report (reportQuantity, or reportQuantity in the CSI-ReportConfig) is set/configured as ‘cri-RI-i1-CQI’ (via RRC signaling).

Optionally, the report quantity of the CSI report (configuration parameter) being CRI, RI and CQI may refer to that the report quantity parameter of the CSI report (reportQuantity, or reportQuantity in the CSI-ReportConfig) is set/configured as ‘cri-RI-CQI’ (via RRC signaling).

Optionally, the report quantity of the CSI report (configuration parameter) being CRI and (L1-)RSRP may refer to that the report quantity parameter of the CSI report (reportQuantity, or reportQuantity in the CSI-ReportConfig) is set/configured as ‘cri-RSRP’ (via RRC signaling).

Optionally, the report quantity of the CSI report (configuration parameter) being SSBRI and RSRP may refer to that the report quantity parameter of the CSI report (reportQuantity, or reportQuantity in the CSI-ReportConfig) is set/configured as ‘ssb-Index-RSRP’ (via RRC signaling).

Optionally, the report quantity of the CSI report (configuration parameter) being none may refer to that the report quantity parameter of the CSI report (reportQuantity, or reportQuantity in the CSI-ReportConfig) is set/configured as ‘none’ (via RRC signaling).

Optionally, the CSI report is a periodic L1-RSRP report.

Optionally, the CSI report is a periodic CSI report other than L1-RSRP.

Details and examples about the cell/network DRX configuration information may refer to the description in Method I.

Details and examples about the first time may refer to the description in Method I. In the embodiments of the disclosure, the CSI report within the first time may refer to that a transmission occasion related to the CSI report (e.g., a PUCCH transmission occasion or PUSCH transmission occasion for transmitting the CSI report) is within the first time. For example, when a (PUSCH or PUCCH) transmission occasion associated with a semi-persistent or periodic CSI report is within the first time (e.g., within the cell DRX active period), the UE reports the CSI report in the transmission occasion. Otherwise, the UE discards/drops the CSI report.

Details and examples about the second time may refer to the description in Method I.

Optionally, the UE receives (indication) information for determining the first time prior to receiving information for triggering the CSI report, which may refer to that the UE receives the (indication) information (e.g., a second DCI format) for determining the first time prior to receiving the information (e.g., a first DCI format) for triggering the CSI report. Optionally, the second DCI format preceding the first DCI format may refer to that the PDCCH associated with the second DCI format is X time units after the PDCCH associated with the first DCI format. Optionally, X time units are predefined. For example, the X time units may be 14 or 28 symbols. Optionally, X may be provided by UE capacity information (reported by the UE). Optionally, X may be configured by higher layer signaling (e.g., RRC signaling).

According to Method II of the embodiments of the disclosure, whether the UE transmits or discards/drops the CSI report is defined under a particular condition. Therefore, a situation that the UE reports an inaccurate CSI in case of not satisfying the condition is avoided, thus improving the reliability of the communication system.

### Method III

In Method III, if a third predefined condition is satisfied, the UE may determine a CSI parameter or report a CSI report according to a fifth frequency domain parameter. The third predefined condition may include at least one of the following:
The UE receives a CSI report configuration parameter, and the CSI report configuration parameter corresponds to a particular report quantity.
The CSI parameter or the CSI report is associated with a first CSI-RS resource pair.
A CSI reference resource (and/or signaling for triggering the CSI report) is within a third time or the fourth time.

For example, the fifth frequency domain parameter may be determined according to a frequency domain parameter of a (reported) CSI-RS resource pair.

When the third predefined condition is satisfied, the UE may determine the CSI parameter or report the CSI report according to the fifth frequency domain parameter. Optionally, the determination of the CSI parameter may be determination of CSI feedback. The determination of the CSI parameter may also be determination of a report carrying the CSI parameter (that is, determination of the CSI report). Optionally, the CSI parameter may be the CSI feedback. The CSI parameter may be a report carrying the CSI parameter (i.e., the CSI report). For example, the third predefined condition may include at least one of the following:
The UE receives a CSI report configuration parameter, and the CSI report configuration parameter corresponds to a particular report quantity.
The CSI parameter or the CSI report is associated with one or more CSI-RS resource pairs, and/or (an index of) a CSI-RS resource pair of the one or more CSI-RS resource pairs is reported.

The UE may receive a CSI report configuration parameter (e.g., CSI-ReportConfig). Optionally, the CSI report (configuration parameter) corresponds to a particular report quantity. Optionally, the particular report quantity may indicate at least one of the following: CRI, RI, PMI, and CQI; CRI, RI, LI, PMI, and CQI; CRI, RI, and i1; CRI, RI, i1, and CQI; CRI, RI, and CQI; CRI, and RSRP; SSBRI, and RSRP; none.

Optionally, the report quantity of the CSI report being CRI, RI, PMI and CQI may refer to that the report quantity parameter of the CSI report (reportQuantity, or reportQuantity in the CSI-ReportConfig) is set/configured as ‘cri-RI-PMI-CQI’ (via RRC signaling).

Optionally, the report quantity of the CSI report being CRI, RI, LI, PMI and CQI may refer to that the report quantity parameter of the CSI report (reportQuantity, or reportQuantity in the CSI-ReportConfig) is set/configured as ‘cri-RI-LI-PMI-CQI’ (via RRC signaling).

Optionally, the report quantity of the CSI report being CRI, RI and i1 may refer to that the report quantity parameter of the CSI report (reportQuantity, or reportQuantity in the CSI-ReportConfig) is set/configured as ‘cri-RI-i1’ (via RRC signaling).

Optionally, the report quantity of the CSI report being CRI, RI, i1 and CQI may refer to that the report quantity parameter of the CSI report (reportQuantity, or reportQuantity in the CSI-ReportConfig) is set/configured as ‘cri-RI-i1-CQI’ (via RRC signaling).

Optionally, the report quantity of the CSI report being CRI, RI and CQI may refer to that the report quantity parameter of the CSI report (reportQuantity, or reportQuantity in the CSI-ReportConfig) is set/configured as ‘cri-RI-CQI’ (via RRC signaling).

Optionally, the report quantity of the CSI report being CRI and (L1-)RSRP may refer to that the report quantity parameter of the CSI report (reportQuantity, or reportQuantity in the CSI-ReportConfig) is set/configured as ‘cri-RSRP’ (via RRC signaling).

Optionally, the report quantity of the CSI report being SSBRI and RSRP may refer to that the report quantity parameter of the CSI report (reportQuantity, or reportQuantity in the CSI-ReportConfig) is set/configured as ‘ssb-Index-RSRP’ (via RRC signaling).

Optionally, the report quantity of the CSI report being none may refer to that the report quantity parameter of the CSI report (reportQuantity, or reportQuantity in the CSI-ReportConfig) is set/configured as ‘none’ (via RRC signaling).

The CSI parameter or the CSI report may be associated with first CSI-RS resource pair(s). Optionally, the first CSI-RS resource pair(s) may include one or more CSI-RS resource pairs. Optionally, the first CSI-RS resource pair(s) is/are determined according to configuration information from a base station. For example, the UE receives the configuration information from the base station, which is used to configure one or more CSI-RS resource pairs. For example, the UE receives the configuration information from the base station, which is used to configure a CSI-RS resource group and an association relationship between resources in the CSI-RS group. The UE determines one or more CSI-RS resource pairs according to the information on the CSI-RS group and information on the reference resource relationship of the CSI-RS group. For another example, the UE receives the configuration information from the base station, which is used to configure two CSI-RS resource groups. Optionally, the two CSI-RS resource groups include the same number of CSI-RS resources, and these CSI-RS resources have one-to-one correspondence. The UE determines one or more CSI-RS resource pairs according to the two CSI-RS resource groups and a predefined relationship (e.g., a one-to-one correspondence). Optionally, the first CSI-RS resource pair may refer to a CSI-RS resource pair which is reported (of which an index is reported) in one or more CSI-RS resource pairs that the CSI parameter or CSI report is associated with. Optionally, the CSI-RS resource pair (for example, the one or more CSI-RS resource pairs; for another example, the reported CSI-RS resource pair; for yet another example, the first CSI-RS resource pair) is used for channel measurement (and/or interference measurement). Optionally, the characteristics of the CSI-RS resource pair may include (or may refer to) at least one of the following:
Two CSI-RS resources in the CSI-RS resource pair have the same periodicity and/or offset. For example, the two CSI-RS resources have the same periodicity AndOffset parameter.
The two CSI-RS resources in the CSI-RS resource pair are located in the same slot or adjacent slots. Optionally, the time domain offsets of the two CSI-RS resources (e.g., in the same slot (with the offset of 0) or adjacent slots (with the offset of 1)) is predefined or determined according to the configuration information (RRC configuration signaling) (from the base station).
The two CSI-RS resources in the CSI-RS resource pair have the same power parameter. For example, parameters (powerControlOffset) used to represent power offsets of PDSCH RE and NZP CSI-RS RE are the same. For example, the parameters (powerControlOffsetSS) used to represent the power offsets of NZP CSI-RS RE and SSS RE are the same.
The two CSI-RS resources in the CSI-RS resource pair have the same OFDM symbol position(s) in a slot.
The two CSI-RS resources in the CSI-RS resource pair have the same number of (CSI-RS) ports. For example, the port number parameters (e.g., nrofPorts) associated with the two CSI-RS resources are the same.
(CSI-RS) CDM groups of the two CSI-RS resources in the CSI-RS resource pair have the same type. For example, the CDM type parameters (e.g., cdm-Type) associated with the two CSI-RS resources are the same.
The two CSI-RS resources in the CSI-RS resource pair have the same (CSI-RS) frequency domain density. For example, the frequency domain density parameters (e.g., density) associated with the two CSI-RS resources are the same.
The two CSI-RS resources in the CSI-RS resource pair have the same QCL source (reference signal) and QCL type. For example, the two CSI-RS resources correspond to the same QCL type D reference signal. For example, the two CSI-RS resources correspond to/are associated with the same qcl-InfoPeriodicCSI-RS parameter (or correspond to the same TCI state identification or identifier (ID)).
The two CSI-RS resources in the CSI-RS resource pair are associated with the same BWP. For example, the two CSI-RS resources correspond to/are associated with the same BWP(ID) parameter (e.g., BWP-Id).
The two CSI-RS resources in the CSI-RS resource pair are not configured with a repetition parameter (e.g., repetition).
Scrambling IDs (e.g., scramblingID) of the two CSI-RS resources in the CSI-RS resource pair are configured separately.
The two CSI-RS resources in the CSI-RS resource pair are configured or not configured with a TRS parameter (e.g., trs-Info).
The two CSI-RS resources in the CSI-RS resource pair are associated with a CRI (CSI-RS resource indicator) (CRI value).
The two CSI-RS resources in the CSI-RS resource pair are associated with at least one of a CQI, a PMI, a LI, and a RI. Optionally, the CRI corresponds to a rank. Optionally, the PMI corresponds to a codebook.

The CSI report may be associated with one or more CSI-IM resources. Optionally, the one or more CSI-IM resources may be used for interference measurement. Optionally, the one or more CSI-IM resources may be associated with (or be one-to-one mapped to) one or more CSI-RS resources pairs for channel measurement associated with the CSI report. Optionally, a CSI-RS resource pair and the corresponding/associated CSI-IM resource may be quasi-co-located (QCLed) (QCLed with respect to ‘typeD’).

The UE determining the CSI parameter or reporting the CSI report according to the fifth frequency domain parameter may refer to (may be understood) that if the UE is configured to report a CQI index, in the CSI reference resource, the UE determines the CSI parameter according to the fifth frequency domain parameter (e.g., the UE assumes the fifth frequency domain parameter for the purpose of deriving the CSI parameter). The CSI parameter may be, for example, at least one of the CQI index, the PMI and the RI. For example, the CSI parameter may be the CQI index. For example, if the PMI and RI are configured, the CSI parameter may be the CQI index, the PMI, and the RI.

Optionally, the fifth frequency domain resource may be related to at least one of the following:
the frequency domain parameter of the CSI-RS resource pair (e.g., the first CSI-RS resource pair);
the first frequency domain resource;
the second frequency domain resource;
the third frequency domain resource; and
the fourth frequency domain resource.

Optionally, the fifth frequency domain parameter (or the fifth frequency domain resource) may be (or may be associated with) the frequency domain parameter of the CSI-RS resource pair (e.g., the first CSI-RS resource pair). Optionally, in case that the CSI reference resource (and/or the signaling for triggering the CSI report) is within the third time (and/or an uplink time unit and/or flexible time unit (configured by common information) or the fourth time, the fifth frequency domain parameter (or the fifth frequency domain resource) may be (or may be associated with) the frequency domain parameter of the CSI-RS resource pair (e.g., the first CSI-RS resource pair). Optionally, the signaling for triggering (the) CSI report may refer to a DCI format (or the PDCCH associated with the DCI format). Details and examples about the third time and the fourth time may refer to the description in Method I.

Optionally, the frequency domain parameter of the CSI-RS resource pair may refer to (or may be associated with) a union or an intersection of frequency domain resources of the two CSI-RS resources of the CSI-RS resource pair. Optionally, the frequency domain resource of the CSI-RS resource may be a frequency domain resource provided by CSI-RS-ResourceMapping (e.g., CSI-RS). Optionally, the frequency domain resource of the CSI-RS resource may be a number of occupied PRBs. Optionally, the frequency domain resource of the CSI-RS resource may be occupied subcarriers in one PRB.

Optionally, the frequency domain parameter of the CSI-RS resource pair may refer to (or may be associated with) a frequency domain resource of one of the two CSI-RS resources in the CSI-RS resource pair, for example, a frequency domain resource of a predefined CSI-RS resource (with the smallest ID), for example, a frequency domain resource of a CSI-RS resource associated with a particular CRI, and for example, a frequency domain resource of a CSI-RS resource indicated by the base station. Optionally, the frequency domain resource of the CSI-RS resource is a frequency domain resource provided by CSI-RS-ResourceMapping (e.g., CSI-RS). Optionally, the frequency domain resource of the CSI-RS resource includes a number of occupied PRBs. Optionally, the frequency domain resource of the CSI-RS resource may include occupied subcarriers in one PRB.

Optionally, the fifth frequency domain parameter (or the fifth frequency domain resource) may be (or may be associated with) the second frequency domain resource (or the frequency domain resource (in the BWP) other than the first frequency domain resource (and a guard band)). Optionally, in case that the CSI reference resource (and/or the signaling for triggering the CSI report) is in the third time (and/or a downlink time unit and/or flexible time unit (configured by the common information), the fifth frequency domain parameter (or the fifth frequency domain resource) may be (or may be associated with) the second frequency domain resource (or the frequency domain resource (in the BWP) other than the first frequency domain resource (and the guard band)). Optionally, the signaling for triggering (the) CSI report may refer to a DCI format (or PDCCH associated with the DCI format).

Optionally, the fifth frequency domain parameter (or the fifth frequency domain resource) may be (or may be associated with) the third frequency domain resource (or the frequency domain resource (in the BWP) other than the fourth frequency domain resource (and a guard band)). Optionally, in case that the CSI reference resource (and/or the signaling for triggering the CSI report) is in the third time (and/or an uplink time unit and/or flexible time unit (configured by the common information), the fifth frequency domain parameter (or the fifth frequency domain resource) may be (or may be associated with) the third frequency domain resource (or the frequency domain resource (in the BWP) other than the fourth frequency domain resource (and the guard band)). Optionally, the signaling for triggering (the) CSI report may refer to a DCI format (or PDCCH associated with the DCI format).

Optionally, the fifth frequency domain parameter (or the fifth frequency domain resource) may be associated with at least one of the frequency domain parameter of the CSI-RS resource pair, the second frequency domain resource, and the third frequency domain resource. Optionally, the fifth frequency domain parameter (or the fifth frequency domain resource) may be determined according to at least one of the frequency domain parameter of the CSI-RS resource pair, the second frequency domain resource, and the third frequency domain resource.

Optionally, the fifth frequency domain parameter (or the fifth frequency domain resource) may be determined according to a union of the frequency domain resources of the two CSI-RS resources of the CSI-RS resource pair and the second frequency domain resource. For example, the fifth frequency domain resource may be an intersection of a first union and the second frequency domain (or the third frequency domain resource). The first union may be a union of the frequency domain resources of the two CSI-RS resources of the CSI-RS resource pair.

Optionally, for a reported CSI-RS resource pair index (e.g., CRI (value)), the UE may report at least one of a CQI, a RI and a PMI. Optionally, the PMI is associated with a codebook subset restriction parameter (or, determined according to a codebook subset restriction). Optionally, the codebook subset restriction parameter is configured by the base station (via the RRC signaling). Optionally, the RI is associated with a RI restriction parameter (or, determined according to a RI restriction parameter). Optionally, the RI restriction parameter is configured by the base station (via the RRC signaling).

Optionally, the frequency domain granularity of the CSI report may be subband granularity/wideband granularity.

Optionally, the frequency domain granularity of the CSI report may be subband granularity/wideband granularity when the third condition is satisfied.

Optionally, if the CSI report is associated with one or more of the (above) CSI-RS resource pairs, what is reported through the CSI report is the CSI parameter used for the determination in discontinuous frequency domain resources.

In the description of Method III, details and examples about the third time and the fourth time may refer to the description in Method I. In the description of Method III, details and examples about the first frequency domain resource, the second frequency domain resource, the third frequency domain resource and the fourth frequency domain may refer to the description in Method I.

According to Method III of the embodiment of the disclosure, the UE can determine the CSI parameter or report the CSI report according to the frequency domain information of the two CSI-RS resources. Therefore, according to the method, the UE can determine the CSI parameter or report the CSI report using the frequency domain resource (e.g., discontinuous frequency domain resource) in case that the SBFD operation is performed on the base station, thus improving the flexibility of the communication system.

### Method IV

In Method IV, when a fourth predefined condition is satisfied, the UE may determine a CSI parameter or report a CSI report according to a sixth frequency domain parameter. The fourth predefined condition includes at least one of the following:
The UE receives a CSI report configuration parameter, and the CSI report configuration parameter corresponds to a particular report quantity.
A CSI reference resource is within a third time or a fourth time.

For example, the sixth frequency domain parameter may be determined according to a frequency domain parameter of a (reported) CSI-RS resource.

In some implementations, when the fourth predefined condition is satisfied, the UE may determine the CSI parameter or report the CSI report according to the sixth frequency domain parameter. Optionally, the determination of the CSI parameter may be the determination of CSI feedback. The determination of the CSI parameter may also be the determination of a report carrying the CSI parameter (that is, the determination of the CSI report). Optionally, the CSI parameter may be a CSI feedback. The CSI parameter may be a report carrying the CSI parameter (i.e., the CSI report). In the embodiments of the disclosure, the terms “CSI”, “CSI parameter”, “CSI report” and “CSI feedback” may be used interchangeably. For example, the fourth predefined condition may include at least one of the following:
The UE receives a CSI report configuration parameter, and the CSI report configuration parameter corresponds to a particular report quantity.
The CSI reference resource is within the third time.

In some examples, the UE may receive the CSI report configuration parameter (e.g., CSI-ReportConfig). Optionally, the CSI report (configuration parameter) corresponds to a particular report quantity. Optionally, the particular report quantity may refer to at least one of the following: CRI, RI, PMI, and CQI; CRI, RI, LI, PMI, and CQI; CRI, RI, and i1; CRI, RI, i1, and CQI; CRI, RI, and CQI; CRI, and RSRP; SSBRI, and RSRP; none.

For example, the report quantity of the CSI report being CRI, RI, PMI and CQI may refer to that the report quantity parameter of the CSI report (reportQuantity, or reportQuantity in the CSI-ReportConfig) is set/configured as ‘cri-RI-PMI-CQI’ (via RRC signaling).

For example, the report quantity of the CSI report being CRI, RI, LI, PMI and CQI may refer to that the report quantity parameter of the CSI report (reportQuantity, or reportQuantity in the CSI-ReportConfig) is set/configured as ‘cri-RI-LI-PMI-CQI’ (via RRC signaling).

For example, the report quantity of the CSI report being CRI, RI and i1 may refer to that the report quantity parameter of the CSI report (reportQuantity, or reportQuantity in the CSI-ReportConfig) is set/configured as ‘cri-RI-i1’ (via RRC signaling).

For example, the report quantity of the CSI report being CRI, RI, i1 and CQI may refer to that the report quantity parameter of the CSI report (reportQuantity, or reportQuantity in the CSI-ReportConfig) is set/configured as ‘cri-RI-i1-CQI’ (via RRC signaling).

For example, the report quantity of the CSI report being CRI, RI and CQI may refer to that the report quantity parameter of the CSI report (reportQuantity, or reportQuantity in the CSI-ReportConfig) is set/configured as ‘cri-RI-CQI’ (via RRC signaling).

For example, the report quantity of the CSI report being CRI and (L1-)RSRP may refer to that the report quantity parameter of the CSI report (reportQuantity, or reportQuantity in the CSI-ReportConfig) is set/configured as ‘cri-RSRP’ (via RRC signaling).

For example, the report quantity of the CSI report being SSBRI and RSRP may refer to that the report quantity parameter of the CSI report (reportQuantity, or reportQuantity in the CSI-ReportConfig) is set/configured as ‘ssb-Index-RSRP’ (via RRC signaling).

For example, the report quantity of the CSI report being none may refer to that the report quantity parameter of the CSI report (reportQuantity, or reportQuantity in the CSI-ReportConfig) is set/configured as ‘none’ (via RRC signaling).

The UE determining the CSI parameter or reporting the CSI report according to the sixth frequency domain parameter may refer to (may be understood) that if the UE is configured to report the CQI index, in the CSI reference resource, the UE determines the CSI parameter according to the sixth frequency domain parameter (e.g., the UE assumes the sixth frequency domain parameter for the purpose of deriving the CSI parameter). The CSI parameter may be, for example, at least one of the CQI index, the PMI, and the RI. For example, the CSI parameter may be the CQI index. For example, if the PMI and RI are configured, the CSI parameter may be the CQI index, PMI and RI.

Optionally, the sixth frequency domain resource may be associated to at least one of the following:
the frequency domain parameter of the CSI-RS resource (e.g., the first CSI-RS resource;
the first frequency domain resource;
the second frequency domain resource;
the third frequency domain resource; and
the fourth frequency domain resource.

Optionally, the sixth frequency domain parameter (or the sixth frequency domain resource) may be (or may be associated with) the frequency domain parameter of the CSI-RS resource (e.g., the first CSI-RS resource). Optionally, the CSI-RS resource is associated with (above) CSI parameter or CSI report. Optionally, in case that the CSI reference resource (and/or the signaling for triggering the CSI report) is in the third time (and/or an uplink time unit and/or flexible time unit (configured by the common information) or the fourth time, the sixth frequency domain parameter (or the sixth frequency domain resource) may be (or may be associated with) the frequency domain parameter of the CSI-RS resource (e.g., the first CSI-RS resource). Optionally, the signaling for triggering (the) CSI report may refer to a DCI format (or PDCCH associated with the DCI format).

Optionally, the frequency domain parameter of the CSI-RS resource may be (or may be associated with) a frequency domain resource provided by CSI-RS-ResourceMapping (e.g., CSI-RS). Optionally, the frequency domain resource of the CSI-RS resource may be the number of occupied PRBs. Optionally, the frequency domain resource of the CSI-RS resource may be occupied subcarriers in one PRB.

Optionally, the sixth frequency domain parameter (or the sixth frequency domain resource) may be (or may be associated with) the second frequency domain resource (or the frequency domain resource (in the BWP) other than the first frequency domain resource (and a guard band)). Optionally, in case that the CSI reference resource (and/or the signaling for triggering the CSI report) is in the third time (and/or a downlink time unit and/or flexible time unit (configured by the common information), the sixth frequency domain parameter (or the sixth frequency domain resource) may be (or may be associated with) the second frequency domain resource (or the frequency domain resource (in the BWP) other than the first frequency domain resource (and a guard band)). Optionally, the signaling for triggering (the) CSI report may refer to a DCI format (or PDCCH associated with the DCI format).

Optionally, the sixth frequency domain parameter (or the sixth frequency domain resource) may be (or may be associated with) the third frequency domain resource (or the frequency domain resource (in the BWP) other than the fourth frequency domain resource (and a guard band)). Optionally, in case that the CSI reference resource (and/or the signaling for triggering the CSI report) is in the third time (and/or an uplink time unit and/or flexible time unit (configured by the common information), the sixth frequency domain parameter (or the sixth frequency domain resource) may be (or may be associated with) the third frequency domain resource (or the frequency domain resource (in the BWP) other than the fourth frequency domain resource (and a guard band)). Optionally, the signaling for triggering (the) CSI report may refer to a DCI format (or PDCCH associated with the DCI format).

Optionally, the sixth frequency domain parameter (or the sixth frequency domain resource) may be associated with at least one of the frequency domain parameter of the CSI-RS resource, the second frequency domain resource, and the third frequency domain resource. Optionally, the sixth frequency domain parameter (or the sixth frequency domain resource) may be determined according to at least one of the frequency domain parameter of the CSI-RS resource, the second frequency domain resource, and the third frequency domain resource.

Optionally, the sixth frequency domain parameter (or the sixth frequency domain resource) may be determined according to the frequency domain resource of the CSI-RS resource and the second frequency domain resource (or the third frequency domain resource). For example, the fifth frequency domain resource may be (or may include) an intersection of the frequency domain resource of the CSI-RS resource and the second frequency domain resource (or the third frequency domain resource).

Optionally, when the fourth predefined condition is satisfied, the frequency domain granularity of the CSI report may be subband granularity or wideband granularity.

In the description of Method IV, details and examples about the third time and the fourth time may refer to method I. In the description of Method IV, details and examples about the first frequency domain resource, the second frequency domain resource, the third frequency domain resource and the fourth frequency domain may refer to method I.

According to Method IV in the embodiment of the disclosure, the UE can determine the CSI parameter or report the CSI report according to particular time domain information and frequency domain information (e.g., the time domain information and frequency domain information for SBFD operations). Therefore, according to the method, the UE can determine the CSI parameter or report the CSI report in case that the SBFD operation is performed on the base station, thus improving the flexibility of the communication system.

### Method V

In the method V, the UE may receive first information, where the first information is associated with power parameter(s) and/or spatial domain parameter(s). The UE then may determine a CSI parameter or report a CSI report according to the power parameter(s) and/or the spatial domain parameter(s).

Optionally, the UE determining the CSI parameter or reporting the CSI report according to the power parameter(s) and/or the spatial domain parameter(s) may refer to that if a fifth predefined condition is satisfied, the UE may determine the CSI parameter or report the CSI report according to the power parameter(s) and/or the spatial domain parameter(s). The fifth predefined condition may include at least one of the following:
A configured report quantity includes: a CSI reference signal resource indicator CRI, a rank indicator RI, a precoding matrix indicator PMI, and a channel quality indicator CQI.
The configured report quantity includes: the CRI, the RI, a layer indicator LI, the PMI, and the CQI.
The configured report quantity includes: the CRI, the RI, and a codebook-related parameter.
The configured report quantity includes: the CRI, the RI, the codebook-related parameter, and the CQI.
The configured report quantity includes: the CRI, the RI, and the CQI.
The first information is carried in first signaling, and the first signaling is also used to trigger or activate a first CSI report associated with the CSI parameter.
The CSI report or the CSI report associated with the CSI parameter is at least one of a periodic CSI report, a semi-persistent CSI report, or an aperiodic CSI report.

For example, the configured report quantity including CRI, RI, PMI and CQI may refer to that the report quantity parameter of the CSI report (reportQuantity, or reportQuantity in the CSI-ReportConfig) is set/configured as ‘cri-RI-PMI-CQI’ (via RRC signaling).

For example, the configured report quantity including CRI, RI, LI, PMI and CQI may refer to that the report quantity parameter of the CSI report (reportQuantity, or reportQuantity in the CSI-ReportConfig) is set/configured as ‘cri-RI-LI-PMI-CQI’ (via RRC signaling).

For example, the configured report quantity including CRI, RI and i1 may refer to that the report quantity parameter of the CSI report (reportQuantity, or reportQuantity in the CSI-ReportConfig) is set/configured as ‘cri-RI-i1’ (via RRC signaling).

For example, the configured report quantity including CRI, RI, i1 and CQI may refer to that the report quantity parameter of the CSI report (reportQuantity, or reportQuantity in the CSI-ReportConfig) is set/configured as ‘cri-RI-i1-CQI’ (via RRC signaling).

For example, the configured report quantity including CRI, RI and CQI may refer to that the report quantity parameter of the CSI report (reportQuantity, or reportQuantity in the CSI-ReportConfig) is set/configured as ‘cri-RI-CQI’ (via RRC signaling).

For example, the first information may be carried in first signaling. The first signaling may be, for example, one of the RRC, MAC CE, and DCI signaling. Optionally, the first signaling may also be used to trigger or activate a CSI report associated with the CSI parameter.

Optionally, the first information may include/may be associated with power information (e.g., power configuration information).

Optionally, (the power information associated with) the first information may at least be used to indicate a (downlink) power parameter.

Optionally, the first information may include/may be associated with one or more power parameters (e.g., power offset parameters, powerControlOffset, of a physical downlink shared channel (PDSCH) resource element (RE) and a non-zero power (NZP) channel state information reference signal resource element (CSI-RS RE). For example, the first information may include/may be associated with a list of power parameters.

Optionally, the first information may include/may be associated with spatial domain information (e.g., spatial domain configuration information).

Optionally, (the spatial domain information associated with) the first information may at least be used to indicate a spatial domain parameter. For example, the spatial domain parameter may include a codebook parameter. For example, the spatial domain parameter may include a port parameter.

Optionally, the first information may include/may be associated with one or more spatial domain parameters. Optionally, the first information (or the spatial domain information) may include/may be associated with one or more codebook configuration parameters (e.g., parameters for configuring Type 1 and Type 2 codebooks, CodebookConfig). Optionally, the first information may include/may be associated with codebook configuration parameters (e.g., parameters for configuring Type 1 and Type 2 codebooks, CodebookConfig). Optionally, the first information (or the spatial domain information) may include/may be associated with one or more port (e.g., antenna port) parameters. For example, the antenna port parameter may be used to indicate the antenna port (e.g., indicate a number of the antenna ports). For example, the antenna port parameter may be used to indicate a number of first dimensions (N1) and a number of second dimensions (N2) of the antenna port, and/or a codebook subset restriction. For example, the codebook subset restriction may be used for a single-panel codebook, and/or a multi-panel codebook.

Optionally, the first information may include/may be associated with power information and spatial domain information. Optionally, the first information may be associated with one or more pairs of power information and spatial domain information. For example, the first information may include indexes of one or more pairs of power information and spatial domain information. For example, a pair of power information and spatial domain information may be {power information #1, spatial domain information #1}.

Optionally, the first information may be associated with one or more pairs of power information and spatial domain information associated with a CSI-RS resource (or a CRI).

Optionally, the first information may include/may be associated with power parameter(s) and/or spatial domain parameter(s). Optionally, the first information may be associated with pairs of power parameters and spatial domain parameters (one or more {power parameter, spatial domain parameter} pairs). Herein, a pair of a power parameter and a spatial domain parameter corresponds to a combination of the power parameter and the spatial domain parameter. For example, a pair of power information and spatial domain information is {power information #1, spatial domain information #1}.

Optionally, the first information includes/is associated with one or more spatial domain parameters associated with the first CSI-RS resource (or the first CRI).

Optionally, the first information includes/is associated with one or more power parameters associated with the first CSI-RS resource (or the first CRI).

Optionally, the first information is associated with one or more pairs of power parameters and/or spatial domain parameters associated with the first CSI-RS resource (or the first CRI).

Optionally, the CSI parameter or CSI report may be associated with the first CSI-RS resource (or the first CRI). Optionally, the CSI parameter or CSI report is based on the first CSI-RS resource (or the first CRI). Optionally, the CSI parameter or CSI report is determined based on the first CSI-RS resource (or the first CRI).

Optionally, the CSI-RS resource (or the CRI) associated with the CSI parameter or CSI report may be the same as the CSI-RS resource (or CRI) associated with one or more pairs of power parameters and/or spatial domain parameters associated with the first information.

Optionally, determining the CSI parameter or reporting the CSI report according to spatial domain parameters and/or power parameters may refer to determining a number of the CSI parameters (e.g., the reported CSI parameters) according to combinations of power parameters associated with the first information and spatial domain parameters associated with the first information. Optionally, determining the CSI parameter or reporting the CSI report according to the spatial domain parameter and/or power parameter may refer to determining a number of the CSI parameters (e.g., the reported CSI parameters) according to (a number of) the power parameters associated with the first information and/or (a number of) the spatial domain parameters associated with the first information. Optionally, the number of the CSI parameters is associated with a number of power parameters associated with the first information and/or a number of the spatial domain parameters associated with the first information. Optionally, the number of the CSI parameters is determined according to the number of the spatial domain parameters associated with the first information and/or the number of power parameters associated with the first information.

Optionally, when the first information includes/is associated with N power parameters and the first information includes/is associated with M spatial domain parameters, the UE may determine the CSI parameter according to a combination of the N power parameters and the M spatial domain parameters. Optionally, the combination of the N power parameters and the M spatial domain parameters may refer to all combinations of the power parameters and the spatial domain parameters, e.g., N*M combinations. Optionally, when the first information includes/is associated with N power parameters and the first information includes/is associated with M spatial domain parameters, a number of the CSI parameters may be associated with N*M. For example, the first information may be associated with a list of power parameters, and the list may include N items (or may be associated with N power parameters). The first information is associated with a spatial domain parameter list, and the list may include M items (or may be associated with M spatial domain parameters). The UE may determine the CSI parameter according to the N*M combinations of the parameters.

Optionally, when the first information includes/is associated with Y pairs of spatial domain parameters and/or power parameters (or Y combinations of spatial domain parameters and/or power parameters), the UE may determine the CSI parameter according to the Y pairs of spatial domain parameters and/or power parameters (or Y combinations of spatial domain parameters and/or power parameters). For example, the first information may be associated with a list of power parameters (or a list of combinations of spatial domain parameters and/or power parameters), and the list may include Y items (or may be associated with Y pairs of spatial domain parameters and/or power parameters). The UE may determine the CSI parameter according to the Y combinations of the parameters.

Optionally, the UE may receive second information. The CSI parameter (e.g., the reported CSI parameter) may be associated with the first information and/or the second information. Optionally, the UE may determine the CSI parameter according to the first information and/or the second information. Optionally, the UE may determine the CSI parameter according to a combination of power parameters and/or spatial domain parameters associated with the first information and/or the second information. Optionally, a number of CSI parameters (e.g., the reported CSI parameters) may be associated with at least one of a number of power parameters associated with the first information, a number of spatial domain parameters associated with the first information, and the second information. Optionally, the number of CSI parameters (e.g., the reported CSI parameters) may be determined according to at least one of the number of power parameters associated with the first information, the number of spatial domain parameters associated with the first information, and the second information.

Optionally, the second information is used for providing restriction. Optionally, the second information is used for restricting/determining the spatial domain parameter(s) and/or the power parameter(s) (or determining a number of the spatial domain parameter(s) and/or the power parameter(s)). Optionally, the second information is used for restricting/determining combinations of the spatial domain parameter(s) and/or the power parameter(s) (or determining a number of combinations of the spatial domain parameter(s) and/or the power parameter(s)). Optionally, the second information is used for determining spatial domain parameters and/or power parameters associated with the first information (or determining a subset of spatial domain parameters and/or power parameters associated with the first information). Optionally, the first information includes/is associated with N power parameters, and the first information includes/is associated with M spatial domain parameters. Here, N*M combinations of the power parameters and/or the spatial domain parameters are provided, and the second information is used for indicating/determining a subset of parameters in the full set of parameters (or in N*M parameters). The UE determines the CSI parameter according to the subset of parameters. Or, the UE determines the CSI parameter according to parameters (or combinations of parameters) other than the subset of parameters, indicated by the second information, in the full set of parameters (N*M combinations of parameters).

Optionally, the second information is used for restricting/determining the power parameter(s) and/or the spatial domain parameter(s). Optionally, the second information is used for determining power parameters associated with the first information (or determining a subset of power parameters associated with the first information). For example, the first information includes/is associated with N power parameters, and the second information is used for indicating/determining a first subset of parameters (N₁ power parameters) in the full set of parameters (e.g., the N power parameters). Optionally, the second information is used for determining spatial domain parameters associated with the first information (or determining a subset of spatial domain parameters associated with the first information). For example, the first information includes/is associated with M spatial domain parameters, and the second information is used for indicating/determining a second subset of parameters (M₁ spatial domain parameters) in the full set of parameters (or the M spatial domain parameters). Optionally, the second information is used for determining spatial domain parameters associated with the first information (e.g., determining a subset of spatial domain parameters associated with the first information). Optionally, the UE determines the CSI parameter according to the first subset of parameters (the N1 power parameters) and/or the second subset of parameters (the M₁ spatial domain parameters). For example, the UE determines the CSI parameter according to (N₁*M₁) combinations of the first subset of parameters (the N₁ power parameters) and/or the second subset of parameters (the M₁ spatial domain parameters). A number of combinations of the power parameter(s) and/or the spatial domain parameter(s) is N₁*M₁. For another example, the UE determines the CSI parameter according to ((N−N₁)*(M−M₁)) combinations of (N−N₁) parameters other than the first subset of parameters (the N₁ power parameters) in the full set of parameters (the power parameters) and (M−M₁) parameters other than the second subset of parameters (the M₁ spatial domain parameters) in the full set of parameters (the spatial domain parameters). The number of combinations of the power parameter(s) and/or the spatial domain parameter(s) is (N−N₁)*(M−M₁).

Optionally, the second information is used for restricting/determining the power parameter(s) and/or the spatial domain parameter(s). Optionally, the second information is used for determining a subset of one or more pairs of power parameters and/or spatial domain parameters associated with the first information (or combinations of spatial domain parameters and/or power parameters). For example, the first information includes/is associated with Y pairs of spatial domain parameters and/or power parameters (or Y combinations of spatial domain parameters and/or power parameters). The second information is used for indicating/determining a third subset of combinations (Y₁ combinations) in the full set of the combinations of parameters (e.g., the Y combinations). For example, the UE determines the CSI parameter according to the third subset of combinations (the Y₁ combinations). A number of combinations of the power parameter(s) and/or the spatial domain parameter(s) is X=Y₁. For another example, the UE determines the CSI parameter according to (Y−Y₁) parameters other than the third subset of combinations (the Y₁ parameters) in the full set of parameters. The number of combinations of the power parameter(s) and/or the spatial domain parameter(s) is Y−Y₁.

Examples of the method for determining the reported CSI parameter according to some embodiments of the disclosure are described below.

The UE may determine a particular number of CSI parameters or report the CSI report (the CSI report includes the particular number of CSI parameters) according to the power parameter(s) and/or the spatial domain parameter(s). Optionally, the particular number is associated with combinations of the power parameter(s) and/or the spatial domain parameter(s) (or, pairs of the parameters (e.g., pairs of the power parameter(s) and the spatial domain parameter(s)). For example, the UE determines K CSI parameters according to the power parameter(s) and/or the spatial domain parameter(s). K is equal to a number of combinations of the power parameter(s) and/or the spatial domain parameter(s). Optionally, a number of the reported CSI parameters is associated with the number of combinations of the power parameter(s) and/or the spatial domain parameter(s) (or the pairs of the parameters (e.g., the pairs of the power parameter(s) and/or the spatial domain parameter(s))). Optionally, the number of the reported CSI parameters is determined according to the number of combinations of the power parameter(s) and/or the spatial domain parameter(s) (or, the pairs of the parameters (e.g., the pairs of the power parameter(s) and the spatial domain parameter(s)). Optionally, the CSI parameter is at least one of CQI, PMI, and RI. Taking the CSI parameter being CQI as an example, when the number of combinations of the power parameter(s) and/or the spatial domain parameter(s) for determining the CSI parameter is a first number, the number of the reported CSI parameters is associated with the first number. For example, when the number of combinations of the power parameter(s) and/or the spatial domain parameter(s) is N*M, a number of the reported CSI parameters is N*M. For example, when the number of combinations of the power parameter(s) and/or the spatial domain parameter(s) is N*M, the CSI report reported by the UE includes N*M CSI parameters (e.g., N*M CQIs).

Optionally, taking the CSI parameter being CQI as an example, one or more reported CQIs are coded separately or jointly. Optionally, the one or more CQIs correspond to the same CQI table. Optionally, the UE also reports the CQI table corresponding to the one or more CQIs. For example, the UE reports information of the CQI table, and the information represents the CQI table corresponding to the one or more CQIs (or the used CQI table). For example, the UE reports information of one or more CQI tables, and the information respectively represents the CQI tables corresponding to the one or more CQIs (or the used CQI tables). Optionally, the information of the one or more CQI tables is in one-to-one correspondence with the one or more CQIs.

Optionally, the one or more CQIs are reported in a differential manner. Optionally, when a number of combinations of the power parameter(s) and/or the spatial domain parameter(s) is greater than 1, and/or a number of the one or more CQIs is greater than 1, the one or more CQIs are reported in a differential manner. Optionally, the CSI report includes information on a first CQI (index/position of the first CQI) of the one or more CQIs. Optionally, the first CQI is one of the one or more CQIs with the maximum CQI value. Optionally, the first CQI is a predefined CQI (e.g., the first one of the CQIs) of the one or more CQIs. Optionally, the first CQI corresponds to a CQI table (e.g., one of Table 1 to Table 4). The table includes 16 items (e.g., a number of items of the table is 16). Optionally, the first CQI corresponds to 4 bits (or, the first CQI is represented by 4 bits). For example, (when the number of combinations of the power parameter(s) and the spatial domain parameter(s) is 4), values of one or more (corresponding) CQIs are respectively {9,8,10,11}, the maximum value of the CQI is 11, and thus the CSI report includes an index (e.g., position index) corresponding to the CQI with the maximum value, for example, the fourth bit (e.g., the index of 3). For example, ‘0’ represents the first bit, ‘1’ represents the second bit, and so on.

TABLE 1

| CQI | | Code rate × | |
|---|---|---|---|
| Index | Modulation | 1024 | Efficiency |

| | |
|---|---|
| 0 | Out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

TABLE 2

| CQI | | Code rate × | |
|---|---|---|---|
| index | Modulation | 1024 | Efficiency |

| | |
|---|---|
| 0 | Out of range |

| | | | |
|---|---|---|---|
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |

TABLE 3

| CQI | | Code rate × | |
|---|---|---|---|
| index | Modulation | 1024 | Efficiency |

| | |
|---|---|
| 0 | Out of range |

| | | | |
|---|---|---|---|
| 1 | QPSK | 30 | 0.0586 |
| 2 | QPSK | 50 | 0.0977 |
| 3 | QPSK | 78 | 0.1523 |
| 4 | QPSK | 120 | 0.2344 |
| 5 | QPSK | 193 | 0.3770 |
| 6 | QPSK | 308 | 0.6016 |
| 7 | QPSK | 449 | 0.8770 |
| 8 | QPSK | 602 | 1.1758 |
| 9 | 16QAM | 378 | 1.4766 |
| 10 | 16QAM | 490 | 1.9141 |
| 11 | 16QAM | 616 | 2.4063 |
| 12 | 64QAM | 466 | 2.7305 |
| 13 | 64QAM | 567 | 3.3223 |
| 14 | 64QAM | 666 | 3.9023 |
| 15 | 64QAM | 772 | 4.5234 |

TABLE 4

| CQI | | Code rate × | |
|---|---|---|---|
| index | Modulation | 1024 | Efficiency |

| | |
|---|---|
| 0 | Out of range |

| | | | |
|---|---|---|---|
| 1 | QPSK | 78 | 0.1523 |
| 2 | QPSK | 193 | 0.377 |
| 3 | QPSK | 449 | 0.877 |
| 4 | 16QAM | 378 | 1.4766 |
| 5 | 16QAM | 616 | 2.4063 |
| 6 | 64QAM | 567 | 3.3223 |
| 7 | 64QAM | 666 | 3.9023 |
| 8 | 64QAM | 772 | 4.5234 |
| 9 | 64QAM | 873 | 5.1152 |
| 10 | 256QAM | 711 | 5.5547 |
| 11 | 256QAM | 797 | 6.2266 |
| 12 | 256QAM | 885 | 6.9141 |
| 13 | 256QAM | 948 | 7.4063 |
| 14 | 1024QAM | 853 | 8.3301 |
| 15 | 1024QAM | 948 | 9.2578 |

Optionally, CQIs other than the first CQI in the one or more CQIs are represented by differential CQIs. Optionally, the CQIs other than the first CQI in the one or more CQIs are represented by CQI offsets. Optionally, an offset value of a second CQI other than the first CQI in the one or more CQIs is determined according to the first CQI. The second CQI correspond to a CQI table (e.g., Table 5). Optionally, the table includes 4 items (e.g., a number of the items of the table is 4). Optionally, the table is used for determining the differential CQIs. Optionally, the second CQI correspond to 2 bits (or, the offset between the second CQI and the first CQI is represented by 2 bits). Taking the CQIs being {9, 8, 10, 11} as an example, 11 is the maximum value of the CQIs (the first CQI), and the {9, 8, 10} are the second CQIs. The differential CQIs (differential CQI levels) corresponding to the CQIs are {2, 3, 1}. As can be seen from Table 5, the corresponding offset levels are {2, 2, 1}. The CSI report includes the offset levels.

Optionally, (e.g., in the CSI report), a CIQ value of the first CQI, index information of the first CQI and value(s) corresponding to the second CQI(s) (e.g., offset level(s)) are coded jointly. Optionally, (e.g., in the CSI report), at least two of the CIQ value of the first CQI, the index information of the first CQI and offset value(s) corresponding to the second CQI(s) (e.g., the offset level(s)) are coded jointly. Optionally, the offset value(s) corresponding to the second CQI(s) are coded jointly.

TABLE 5

| Differential CQI value | Offset level |
|---|---|
| 0 | 0 |
| 1 | 1 |
| 2 | ≥2 |
| 3 | ≤−1 |

Optionally, taking the CSI parameter being PMI as an example, one or more reported PMIs are coded separately or jointly. Optionally, the one or more PMIs correspond to the same PMI table. Optionally, the UE also reports the PMI table corresponding to the one or more PMIs. For example, the UE reports information of a PMI table, and the information represents PMI tables corresponding to the one or more PMIs (or used PMI tables). For example, the UE reports information of one or more PMI tables, and the information respectively represents the PMI tables corresponding to the one or more PMIs (or used PMI tables). Optionally, the information of one or more PMI tables is in one-to-one correspondence with one or more PMIs.

Optionally, the one or more PMIs are reported in a differential manner. Optionally, when a number of combinations of the power parameter(s) and/or the spatial domain parameter(s) is greater than 1, and/or a number of the one or more PMIs is greater than 1, the one or more PMIs are reported in a differential manner. Optionally, the CSI report includes information on a first PMI (index/position of the first PMI) of the one or more PMIs. Optionally, the first PMI is a CQI of the one or more CQIs with the maximum PMI value. Optionally, the first PMI is a predefined PMI (e.g., the first one of the PMIs) of the one or more PMIs. Optionally, the first PMI corresponds to a PMI table. Optionally, the first PMI corresponds to 4 bits (or, the first CQI is represented by 4 bits). For example (a number of combinations of the power parameters and spatial domain parameters is 4), values of one or more (corresponding) PMIs are {9,8,10,11}, respectively, the maximum value of the PMI is (e.g., 11), and thus the CSI report includes an index (e.g., position index) corresponding to the PMI, for example, the fourth bit (e.g., the index is 3). For example, ‘0’ represents the first bit, ‘1’ represents the second bit, and so on.

Optionally, PMIs other than the first PMI in the one or more PMIs are represented by differential PMIs. Optionally, the PMIs other than the first PMI in the one or more PMIs are represented by PMI offsets. Optionally, offset values of second PMIs other than the first PMI in the one or more PMIs are determined according to the first PMI. The second PMIs correspond to a PMI table. Optionally, the table includes 4 items (e.g., a number of the items of the table is 4). Optionally, the table is used for determining the differential PMIs. Optionally, the second PMIs correspond to 4 bits (or, the second PMIs are represented by 2 bits). Taking the PMIs being {9, 8, 10, 11} as an example, 11 is the maximum value of the PMIs (the first PMI), and the {9, 8, 10} are the second PMIs. The differential PMIs (differential PMI levels) corresponding to the PMIs are {2, 3, 1}. As can be seen from Table 5, the corresponding offset levels are {2, 2, 1}. The CSI report includes the offset levels.

Optionally, (e.g., in the CSI report), the PMI value of the first PMI, the index information of the first PMI and value(s) corresponding to the second PMI(s) (e.g., offset level(s)) are coded jointly. Optionally, (e.g., in the CSI report), at least two of the PMI value of the first PMI, the index information of the first PMI and the offset value(s) corresponding to the second PMI(s) (e.g., the offset level(s)) are coded jointly. Optionally, the offset value(s) corresponding to the second PMIs are coded jointly.

Optionally, taking the CSI parameter being RI as an example, one or more reported RIs are coded separately or jointly. Optionally, values of the one or more RIs are 1.

Optionally, taking the CSI parameter being LI as an example, one or more reported LIs are coded separately or jointly. Optionally, a number of the LI indexes is 1.

Optionally, taking the CSI parameter being CRI as an example, a number of the reported CRI indexes is 1.

Examples of CSI report update according to some embodiments of the disclosure are described below.

Optionally, the UE may update a particular number of CSI reports with high priority (or is not required to update the particular number of CSI reports with low priority), where the particular number is associated with a number of combinations of the power parameter(s) and/or the spatial domain parameter(s). The particular number, for example, is O_{CPU}.

The UE indicates the number of supported simultaneous CSI calculations (N_{CPU}) in a component carrier (CC) by a parameter related to simultaneous CSI per CC (e.g., simultaneousCSI-ReportsPerCC), and indicates a number (N_{CPU}) of supported simultaneous CSI calculations across all CCs by a parameter related to simultaneous CSI across all CC (e.g., simultaneousCSI-ReportsAllCC).

The UE supporting N_{CPU} simultaneous CSI calculations may refer to that the UE has N_{CPU} CSI processing units (CPU) for processing CSI reports. If L CPUs are occupied in a given OFDM symbol, the UE may have N_{CPU}-L unoccupied CPUs.

If N CSI reports start occupying their respective CPUs on the same OFDM symbol on which N_{CPU}-L CPUs are unoccupied, where each CSI report n=0, . . . , N−1 corresponds to O_{CPU} (n), the UE is not required to update the N−M (required/requested) CSI reports with the lowest priority, where 0≤M≤N is the largest value such that

$${Σ}_{n = 0}^{M - 1} {O}_{CPU} ( n ) ⩽ {N}_{CPU} - L$$

holds.

O_{CPU} may be associated with combinations of the power parameter(s) and/or the spatial domain parameter(s). Optionally, the O_{CPU} is associated with the number of combinations of the power parameter(s) and/or the spatial domain parameter(s) (for example, N*M; for another example, Y; for another example, N₁*M₁; for another example, (N−N₁)*(M−M₁); for another example, Y−Y₁; for another example, Y₁). Optionally, when the number of combinations of the power parameter(s) and/or the spatial domain parameter(s) is greater than 1, the O_{CPU} is associated with the number of combinations of the power parameter(s) and/or the spatial domain parameter(s) (for example, N*M; for another example, Y; for another example, N₁*M₁; for another example, (N−N₁)*(M−M₁); for another example, Y−Y₁; for another example, Y₁).

When the CSI report satisfies a sixth predefined condition, the O_{CPU} is associated with the combinations of the power parameter(s) and/or the spatial domain parameter(s), or O_{CPU}=N_{CPU}. The sixth predefined condition may include at least one of the following:
The CSI reference resource associated with the CSI report is in one or more time units. (Indexes) of the one or more time units are determined according to the first information. The time unit, for example, is a slot or a symbol.
The CSI report is triggered aperiodically.
The CSI report does not transmit a PUSCH with HARQ-ACK and/or TB.
No (L=0) CPU is occupied.
The CSI (of the CSI report) corresponds to a single CSI with wideband frequency domain granularity.
The CSI (of the CSI report) corresponds to at most 4 CSI-RS ports in a single resource.
The CSI (of the CSI report) has no CRI report.
The report quantity of the CSI report includes: CRI, RI, and CQI. The report quantity of the CSI report being CRI, RI and CQI may refer to that the report quantity parameter of the CSI report (reportQuantity, or reportQuantity in the CSI-ReportConfig) is set/configured as ‘cri-RI-CQI’ (via RRC signaling).
The codebook type associated with/corresponding to the spatial domain parameter (e.g., the spatial domain parameter in the combinations of the spatial domain parameter(s) and the power parameter(s)) is Type I single panel. For example, the codebook type (codebookType) associated with the first spatial domain parameter is set/configured as ‘typeI-SinglePanel’ (via RRC signaling).
(The time unit of) the DCI format (or the PDCCH corresponding to the DCI format) that triggers the CSI report is (after X time units) after a signal or channel carrying the (latest) second information (or carrying the feedback of the first information) (or the signal or channel carrying the second information (or carrying the feedback of the second information) is no later than the DCI format that triggers the CSI report). X may be predefined or associated with a UE capacity report (e.g., determined according to the UE capacity report).
(The time unit of) the CSI reference resource for the CSI report is (after X time units) after a signal or channel carrying the (latest) second information (or carrying the feedback of the second information) (or the signal or channel carrying the second information (or carrying the feedback of the first information) is no later than the CSI reference resource for the CSI report). X may be predefined or associated with the UE capacity report (e.g., determined according to the UE capacity report).

Optionally, the O_{CPU} being associated with combinations of the power parameter(s) and/or the spatial domain parameter(s) may refer to that the is associated with at least one of the number of combinations of the power parameter(s) and/or the spatial domain parameter(s) and a number of reference signals (resources) associated with the CSI parameter (or the CSI report). Optionally, the number of reference signals (resources) may refer to a number of the reference signals (resources) in the reference signal (resource) set (for channel measurement). Optionally, the reference signal (resource) set is associated with the CSI parameter or CSI report.

For example, when the number of the reference signals (resources) in the reference signal (resource) set is K, and the number of combinations of the power parameter(s) and/or the spatial domain parameter(s) associated with/corresponding to a reference signal resource (or a CRI) is Xₖ, O_{CPU} is equal to

$${Σ}_{k = 1}^{K} {X}_{k} ,$$

or O_{CPU} is equal to

$$a * {Σ}_{k = 1}^{K} {X}_{k} ,$$

or O_{CPU} is equal to a*X₁. Here, k=1, 2, 3, 4 . . . , K. Optionally, ‘a’ is a predefined (coefficient), e.g., one of 0.25, 0.5, 1, 2 and 3. Optionally, ‘a’ is related to the UE capacity report. For example, ‘a’ is determined according to the UE capacity report. Optionally, ‘a’ is configured by higher layer signaling. A determination method for Xₖ may refer to the above method for determining the number of combinations of the power parameter(s) and/or spatial parameter(s) associated with a CSI-RS resource (or a CRI).

For another example, when a number of the reference signals (resources) in the reference signal (resource) set is K, and the number of combinations of the power parameter(s) and/or the spatial domain parameter(s) (associated with/corresponding to each reference signal resource) is X (or both are X), O_{CPU} is equal to K*X, or O_{CPU} is equal to a*K*X, or O_{CPU} is equal to a*X. Optionally, a is a predefined (coefficient), e.g., one of 0.25, 0.5, 1, 2 and 3. Optionally, ‘a’ is related to the UE capacity report. For example, ‘a’ is determined according to the UE capacity report. Optionally, ‘a’ is configured by higher layer signaling. A determination method for X may refer to the above method for determining the number of combinations of power parameters and/or spatial parameters associated with a CSI-RS resource (or a CRI).

Optionally, (when a number of the reference signals (resources) in the reference signal (resource) set is K, and the number of combinations of the power parameter(s) and/or the spatial domain parameter(s) is X, and) a rank restriction is associated with the particular number of layers (e.g., the PMI and RI reports are not allowed to correspond to any precoder associated with a layer with a dedicated number), O_{CPU} is equal to K, or O_{CPU} is equal to a*K, or O_{CPU} is equal to a (or UE assumes/determines/considers Xₖ=1 or Xₖ=1; or, the UE assumes/determines/considers that X=1 or Xₖ=1 during CSI calculation). Optionally, the particular number is predefined. For example, the particular number is 1. Optionally, the particular number is related to the UE capacity report. For example, the particular number is determined according to the UE capacity report. Optionally, the particular number is configured by higher layer signaling.

When the CSI report satisfies the sixth predefined condition and satisfies a seventh predefined condition, O_{CPU} is associated with combinations of the power parameter(s) and/or the spatial parameter(s). The seventh predefined condition may include at least one of the following:
The CSI report configuration is configured with Type 1 single-panel codebook type parameter (e.g., the codebook Type is set as ‘typeI-SinglePanel’).
The CSI-RS resource set (for channel measurement) corresponding to/associated with the CSI report is configured with two resource groups (e.g., Group 1 and Group 2) and N′ resource pairs.

Optionally, the O_{CPU} being associated with combinations of the power parameter(s) and/or the spatial domain parameter(s) may refer to that the O_{CPU} is associated with at least one of the number of combinations of the power parameter(s) and/or the spatial domain parameter(s), the number (e.g., M′) of the reference signals (resources) associated with the CSI parameter (or the CSI report), and the number (e.g., N′) of the reference signal (resource) pairs associated with the CSI parameter (or the CSI report). Optionally, a number of reference signals (resources) may refer to a number of the reference signals (resources) in the reference signal (resource) set (for channel measurement). Optionally, the reference signal (resource) set is associated with the CSI parameter or CSI report. Optionally, when the CSI report is configured as a first mode (e.g., the CSI report mode parameter csi-ReportMode is set as ‘Mode1’), and a single TRP number parameter (e.g., numberOfSingleTRP-CSI-Mode1) is set as 0, M′=0. Optionally, when the CSI report is configured as a second mode (e.g., the CSI report mode parameter csi-ReportMode is set as ‘Mode2’), or when the CSI report is configured as the first mode (e.g., the CSI report mode parameter csi-ReportMode is set as ‘Mode1’), and the single TRP number parameter (e.g., numberOfSingleTRP-CSI-Mode1) is set as 1 or 2, M′ is determined according to numbers of resources in the two resource groups. For example, (when a resource shared parameter (e.g., shared CMR) is configured), M′=K₁+K₂, where K₁ and K₂ are the numbers of resources in the two resource groups, respectively. For example, (when the resource shared parameter (e.g., shared CMR) is not configured), M′ may refer to a number of resources in the two resource groups that are not referenced by any resource pair (of the N′ resource pairs).

For example, when a number of the reference signals (resources) is M′, and the number of combinations of the power parameter(s) and/or the spatial domain parameter(s) associated with/corresponding to a reference signal resource (or a CRI) is Xₘ, O_{CPU} is equal to

$$b * {N}^{′} + a * {\sum }_{m = 1}^{M ′} {X}_{m} ,$$

or O_{CUP} is associated with

$$a * {\sum }_{m = 1}^{M ′} {X}_{m} ,$$

or O_{CPU} is determined according to

$$a * {\sum }_{m = 1}^{M ′} {X}_{m} .$$

Here, m=1, 2, 3, 4 . . . , M′. Optionally, ‘a’ is a predefined (coefficient), e.g., one of 0.25, 0.5, 1, 2 and 3. Optionally, a is related to the UE capacity report. For example, ‘a’ is determined according to the UE capacity report. Optionally, ‘a’ is configured by higher layer signaling. Optionally, ‘b’ is predefined (e.g., 1 or 2), or is related to the UE capacity. For example, ‘b’ is a number of CPUs occupied by one pair of channel measurement resources (CMR) depending on the UE capability.

Optionally, if the CSI-RS resource corresponding to/associated with the Xₘ is in a first group (e.g., Group 1) or a second group (e.g., Group 2) of the two resource groups, Xₘ=1. Optionally, if the CSI-RS resource corresponding to/associated with Xₘ is in the second group (e.g., Group 2) or the first group (e.g., Group 1) of the two resource groups, a determination method for Xₘ may refer to the above method for determining the number of combinations of power parameters and/or spatial parameters associated with a CSI-RS resource (or a CRI).

According to the method V of the embodiments of the disclosure, the UE may calculate or report the CSI parameter according to one or more combinations of power parameters and/or spatial domain parameters. Therefore, the base station may flexibly select the power parameters and/or spatial parameters for downlink transmission after receiving the CSI feedback corresponding to the combinations, so as to improve the scheduling flexibility of the base station.

In communication systems (e.g., NR), beam management may be performed, for example, a transmission and reception point (TRP) and a UE beam used for a communication between a UE and a base station are dynamically selected based on a channel quality. The UE may perform beam failure detection (e.g., by measuring a reference signal (e.g., CSI-RS or SSB)), so as to determine whether the beam failure occurs or not. When the beam failure occurs, a beam failure recovery process may be performed. It is necessary to consider cell/network DTX/DRX for beam failure detection and beam failure recovery.

### Method VI

For the sake of description, details and examples of the beam management process by the UE are described at first.

In an implementation, the UE receives configuration information from a network device, and performs a corresponding beam failure recovery process according to the configuration information. The following describes the beam failure recovery process of the UE by taking a downlink control information (DCI) format in which the beam failure recovery response is cyclic redundancy check (CRC) scrambled by a cell radio network temporary identifier (C-RNTI) or a modulation and demodulation scheme temporary identifier (MCS-C-RNTI) as an example.

The UE may be provided, for each bandwidth part (BWP) of a serving cell, a set (q₀) (which may be called a first set for the sake of description) of periodic channel state information reference signal (CSI-RS) resource configuration indexes by a failure detection resource list parameter (e.g., failureDetectionResourcesToAddModList). Also, the UE may be provided with a set (q₁) of periodic CSI-RS resource configuration indexes and/or synchronization signal block (SSB) indexes for radio link quality measurements on the BWP of the serving cell by candidate beam reference signal list parameters (e.g., candidateBeamRSList or candidateBeamRSListExt).

If the UE is not provided q₀ by the failure detection resource list parameter for a BWP of the serving cell, the UE determines the set q₀ to include periodic CSI-RS resource configurations indexes with same values as the reference signal indexes (the reference signal indexes in the reference signal sets indicated by transmission control indicator (TCI) state for respective CORESETs that the UE uses for monitoring physical downlink control channel (PDCCH)).

If there are two reference signal indexes in a TCI state, the set q₀ includes reference signal indexes configured with quasi-co-located (QCL) type D (e.g., configured with qcl-Type set to ‘typeD’) for the corresponding TCI states.

The UE expects that the set q₀ includes up to two reference signal indexes. For example, the set q₀ provided/configured to the UE at most includes two reference signal indexes.

The UE expects that a reference signal in the set q₀ is a single-port reference signal. For example, the reference signal in the set q₀ provided/configured to the UE is single-port.

The UE expects that a reference signal in the set q₀ is a single-port reference signal or a two-port reference signal with a frequency domain density equal to 1 resource element (RE) (or 3 REs) per resource block (RB). For example, the UE expects that a reference signal in the q provided to/configured to the UE is a single-port reference signal, or a two-port reference signal with frequency domain density equal to 1 RE (or 3 REs) per RB.

A threshold Q_{out,LR} corresponds to a default value of a block error rate (BLER) threshold parameter (the threshold Q_{out,LR} is determined according to the default value). The threshold parameter BLER is an index of a BLER threshold pair for synchronization/out-of-synchronization indication generation (e.g., rlmInSyncOutOfSyncThreshold). The threshold Q_{in,LR} corresponds to a value provided by a reference signal reception power (L1-RSRP) threshold parameter of Layer 1. The L1-RSRP threshold parameter (e.g., rsrp-ThresholdSSB or rsrp-ThresholdBFR) may refer to an L1-RSRP threshold for determining whether a candidate beam can be used by the UE.

The physical layer in the UE assesses radio link quality according to the set q₀ of resource configurations against the threshold Q_{out,LR}. For the set q₀, the UE assesses the radio link quality only according to SSBs on the primary cell (PCell) or primary secondary cell (PSCell) or periodic CSI-RS resource configurations. The SSBs or CSI-RSs are quasi co-located with the demodulation reference signal (DM-RS) of PDCCH receptions by the UE. The UE applies the threshold Q_{in,LR} to the L1-RSRP measurement obtained from a SSB. The UE applies the threshold Q_{in,LR} to the L1-RSRP measurement obtained from a CSI-RS after scaling a respective CSI-RS reception power with a value provided by a power offset parameter. The power offset parameter (e.g., powerControlOffsetSS) refers to a power offset between a non-zero power state channel information reference signal resource element (NZP CSI-RS RE) and a secondary synchronous signal resource element (SSS RE).

In the operation of a discontinuous reception (DRX) mode, when the radio link quality for all resource configurations in the set q₀ that the UE uses to assess the radio link quality is worse than the threshold Q_{out,LR}, the physical layer of the UE provides an indication to higher layers. The physical layer informs the higher layers when the radio link quality is worse than the threshold Q_{out,LR} with a periodicity. The periodicity is determined according to the maximum value of one of the following:
the shortest periodicity of the periodicity of SSBs on the PCell/PSCell and/or the periodicity of the periodic resource configurations in the set q₀ that the UE uses to assess the radio link quality;
2 milliseconds.

In the operation of the DRX mode, the physical layer of the UE provides an indication to higher layers when the radio link quality is worse than the threshold Q_{out,LR} with a periodicity.

For the PCell or the PSCell, upon request from higher layers, the UE provides the higher layers with the periodic reference signal indexes and/or SSB indexes from the set q₁ with L1-RSRP measurements that are greater than or equal to the threshold value Q_{in,LR}, and the UE provides the higher layers with the L1-RSRP measurements (e.g., measurement values) corresponding to the index of the periodic reference signal and/or SSB.

In an implementation, a higher layer of the UE (e.g., a media access control (MAC) layer) provides the (physical layer of) the UE with an index q_{new}. Optionally, the index q_{new} is selected from the set q by the higher layer of the UE. Optionally, the index q_{new} is selected from the periodic reference signal indexes and/or SSB indexes (provided by the UE to the higher layer) from the set q₁ with L1-RSRP measurements that are greater than or equal to the threshold value Q_{in,LR}.

For the PCell or PSCell, the UE may be configured with a control resource set (CORESET) through a link to a search space set. The search space set is provided by a recovery search space parameter (e.g., recoverySearchSpaceId). The recovery search space parameter is a search space for indicating beam failure recovery random access feedback (RAR).

For the PCell or PSCell, the UE may be provided with a PRACH transmission configuration by a physical random-access channel (PRACH) resource parameter. The PRACH resource parameter (e.g., PRACH-ResourceDedicatedBF) is used for configuring a beam failure recovery dedicated resource (e.g., dedicated reference signal resource). For a PRACH transmission in a slot n and according to antenna port quasi-co-location parameter (e.g., the antenna port quasi-co-location parameter is associated with periodic CSI-RS configuration indexes or with SSB associated with the index q_{new} provided by the higher layer), the UE monitors for PDCCH in a window on the CORESET associated with the search space set provided by the recovery search space parameter. The window is configured by a beam failure recovery parameter (e.g., BeamFailureRecoveryConf), and is used for detecting a downlink control information format with CRC scrambled by C-RNTI or MCS-C-RNTI starting from a slot n+4. For PDCCH monitoring in the search space and for corresponding PDCCH receptions where the recovery search space parameter is configured, the UE assumes/determines/considers that the same antenna port quasi-collocation parameters as the ones associated with index q_{new} until the UE receives by higher layers an activation for a TCI state or any of TCI state parameters of physical downlink control channel (e.g., tci-StatesPDCCH-ToAddList and/or tci-StatesPDCCH-ToReleaseList). The TCI state parameter of the physical downlink control channel is used for providing a quasi-co-location relationship between a downlink reference signal (or the TCI state) and a PDCCH demodulation reference signal port.

After the UE detects a downlink control information format with CRC scrambled by C-RNTI or MCS-C-RNTI in the search space provided by the recovery search space parameter, the UE continues to monitor PDCCH candidates in the search space until the UE receives a MAC CE activation command for a TCI state or the TCI state parameter of the physical downlink control channel (e.g., tci-StatesPDCCH-ToAddList and/or tci-StatesPDCCH-ToReleaseList).

For the PCell and PSCell, after 28 symbols from a last symbol of a first PDCCH in the search space provided by the recovery search space parameter (e.g., a search space where the UE detects a downlink control information format with CRC scrambled by C-RNTI or MCS-C-RNTI), and until the UE receives a MAC CE activation command or the UE is provided with a PUCCH spatial relationship parameter (e.g., PUCCH-SpatialRelationInfo) for physical uplink control channel (PUCCH) resource(s), the UE, on a cell that is the same as the last PRACH transmission, transmits a PUCCH using a spatial domain filter (which may also called spatial filter) that is the same as the last PRACH transmission.

For the PCell and PSCell (and for q₀ and q₁), after 28 symbols from a last symbol of the PDCCH reception in the search space provided by the recovery search space parameter (e.g., a search space where the UE detects a downlink control information format with CRC scrambled by C-RNTI or MCS-C-RNTI), the UE assumes/determines/considers same antenna port quasi-collocation parameters as the ones associated with index q_{new} for PDCCH monitoring in a CORESET with index 0.

If the UE is provided with a TCI state parameter (e.g., TCI-State_r17 or TCI-State) to indicate a unified TCI state for the PCell or a PSCell, after 28 symbols from a last symbol of the PDCCH reception in the search space provided by the recovery search space parameter (e.g., a search space where the UE detects a downlink control information format with CRC scrambled by C-RNTI or MCS-C-RNTI):
If a SSB measurement time configuration parameter (e.g., SSBMTC-AdditionalPCI) is not provided, the UE monitors PDCCHs in all CORESETs using the same antenna quasi-co-location parameter as ones associated with the index q new, and receives a physical downlink shared channel (PDSCH) and (if there are CSI-RS resources described below) an aperiodic CSI-RS resource in a CSI-RS resource set (where the CSI-RS resource set has the same indicated TCI state as for the PDCCH and PDSCH).
The UE transmits physical uplink shared channel (PUSCH), physical uplink control channel (PUCCH) and sounding reference signal (SRS) using a same spatial filter as that for the last PRACH transmission. The SRS refers to an SRS that uses the same spatial filter as the PUSCH and the PUCCH and has the same indicated TCI state.

In an implementation, the UE receives configuration information from a network device, and performs a corresponding beam failure recovery process according to the configuration information. Taking the beam failure recovery response being the downlink control information format for determining contention based random access procedure as an example, the beam failure recovery process of the UE is described below. The way for the UE to receive the configuration information from the network device is the same as the above embodiments in which the beam failure response is in a downlink control information format with CRC scrambled by C-RNTI or MCSC-RNTI, so the details are not repeated here.

For the PCell and PSCell, if the beam failure recovery MAC CE is provided by a Message 3 (Msg3) or Message A (MsgA) based on the contention based random access procedure, and if a PUCCH resource is provided with the PUCCH spatial relationship parameter, after 28 symbols from a last symbol of the PDCCH reception that determines the completion of the contention based random access procedure, the UE transmits the PUCCH on a same cell as the last PRACH transmission using the same spatial domain filter as the last PRACH transmission.

If the UE is provided with the TCI state parameter (e.g., downlink or joint TCI state list parameter (dl-OrJoint-TCIStateList-r17) or uplink TCI state parameter (UL-TCIstat)) for indicating a unified TCI state for the PCell or PSCell, and the UE provides beam failure recovery MAC CE in Msg3 or MsgA of based random access procedure, after 28 symbols from a last symbol of the PDCCH reception that determines the completion of the contention based random access procedure:
If the SSB measurement time configuration parameter (e.g., SSBMTC-AdditionalPCI) is not provided, the UE monitors PDCCH in all CORESETs using the same antenna quasi-co-location parameter as the ones associated with the index q_{new}, and receives PDSCH and (if there are CSI-RS resources described below) a aperiodic CSI-RS resource in a CSI-RS resource set (where the CSI-RS resource set has the same indicated TCI state as for the PDCCH and PDSCH).
The UE transmits PUSCH, PUCCH and SRS using the same spatial domain filter as for the last PRACH transmission. The SRS refers to an SRS that uses the same spatial domain filter as the PUSCH and the PUCCH and has the same indicated TCI state.

According to some embodiments of the Method VI, when a sixth condition is satisfied, the physical layer of the UE may provide an indication to higher layers (e.g., an indication related to the beam failure detection). The sixth condition may include at least one of the following:
The UE is indicated with the cell DTX. For example, the UE is configured with cell DTX configuration information by RRC signaling. For example, the UE is indicated with cell DRX information by DCI or MAC CE.
The UE is in the cell DTX mode or in an operation of the DTX mode.
The UE is indicated with the cell DRX. For example, the UE is configured with cell DRX configuration information by RRC signaling. For example, the UE is indicated with the cell DRX information by DCI or MAC CE.
The UE is in the cell DRX mode or in an operation the DRX mode.
In the first time or second time (Details about the first time and the second time may refer to the description in Method I).
In a fifth time, the fifth time is related to a spatial domain parameter and/or power parameter. For example, the terminal device receives indication information that indicates the spatial domain parameter and/or power parameter (related to a reference signal), and the fifth time associated with the spatial domain parameter and/or power parameter. Optionally, the fifth time is a time when the spatial domain parameter and/or power parameter are/is applied. For example, the fifth time is indicated based on DCI or MAC CE. Details and examples about the spatial domain parameter and the power parameter may refer to the description above.
The UE is not configured with a failure detection resource list parameter (on BWP of a serving cell).
The radio link quality for all particular resources (particular reference signals) in the first set (or associated with the first set) (e.g., the set q₀) that the UE uses to assess the radio link quality is worse than a particular threshold (e.g., the Q_{out,LR}).

Here, the cell DTX may be called a cell DTX mode. The cell DTX may also be called a network DTX. The cell DTX may also be called a network DTX mode.

Here, the cell DRX may be called a cell DRX mode. The cell DRX may also be called a network DRX. The cell DRX may also be called a network DRX mode.

As above, the sixth condition may include that the radio link quality for all the particular resources (or particular reference signals) in the first set (e.g., the set q₀) that the UE uses to assess the radio link quality is worse than a particular threshold (e.g., Q_{out,LR}). Here, the particular resources may be reference signal resources. For example, the reference signal resource may be a particular reference signal (e.g., SSB and/or CSI-RS). For example, the sixth condition may include that the radio link quality for all SSBs (SSBs on the PCell or PSCell) associated with the set q₀ that the UE uses to assess the radio link quality is worse than a particular threshold (e.g., Q_{out,LR}). For example, the sixth condition may include that the radio link quality for all CSI-RSs (e.g., CSI-RS resources) associated with the set q₀ that the UE uses to assess the radio link quality is worse than a particular threshold (e.g., Q_{out,LR}). For example, the sixth condition may include that the radio link quality for all SSBs associated with CSI-RSs (e.g., the CSI-RS resources) associated with the set q₀ that the UE uses to assess the radio link quality is worse than the particular threshold (e.g., Q_{out,LR}). Optionally, the association between a CSI-RS and a SSB may refer to that the CSI-RS and the SSB are quasi-co-located. Optionally, the association between a CSI-RS and a SSB may refer to that the SSB or the CRI-RS and a reference signal for PDCCH reception by the UE are quasi co-located. Optionally, the association between a CSI-RS and a SSB may refer to that the SSB or the CRI-RS and a demodulation reference signal (DM-RS) for PDCCH reception by the UE are quasi co-located. The method has the advantage that the terminal device can perform the beam failure detection using a corresponding reference signal (e.g., reference signal without being affected by the DRX/DTX operation) in case of the cell DRX/DTX, thus improving the reliability of the communication system.

For example, the sixth condition may include when (the UE is indicated with the cell DTX, or within non-active period(s) of cell DTX, or within the fifth time, and) the UE is not configured with the failure detection resource list parameter on a BWP of a serving cell, and the (corresponding) radio link quality for all SSBs in the first set (e.g., the set q₀) that the UE uses to assess the radio link quality is worse than a particular threshold (e.g., Q_{out,LR}). At this time, on the BWP, the physical layer of the UE may provide an indication to higher layers (e.g., an indication related to the beam failure detection). For example, the SSB that the UE uses to assess the radio link quality may refer to a SSB that is quasi co-located with the reference signal for PDCCH reception by the UE.

For another example, the sixth condition may include when (the UE is indicated with the cell DTX, or within non-active period(s) of cell DTX, or within the fifth time, and) the UE is configured with the failure detection resource list parameter on a BWP of a serving cell, and the (corresponding) radio link quality for all SSBs associated with CSI-RSs in the first set (e.g., the set q₀) that the UE uses to assess the radio link quality is worse than a particular threshold (e.g., Q_{out,LR}). At this time, on the BWP, the physical layer of the UE may provide an indication to higher layers (e.g., an indication related to the beam failure detection). The CSI-RS that the UE uses to assess the radio link quality may refer to the CSI-RS quasi co-located with the reference signal for PDCCH reception by the UE.

Optionally, when the radio link quality is worse than the threshold Q_{out,LR}, the physical layer may informs higher layers with a particular periodicity. Optionally, the particular periodicity is related at least one of the following (or is determined according to at least one of the following; or is determined according to the maximum value/minimum value of at least one of the following):
A periodicity of reference signals in the first set (e.g., the set q₀).
   For example, a periodicity of SSBs (on the PCell/PSCell) (that the UE uses to assess the radio link quality) in q₀. Optionally, the SSB is for the PCell/PSCell. Optionally, the SSB is a SSB that the UE uses to assess the radio link quality.
   For example, a periodicity of CSI-RSs (that the UE uses to the assess radio link quality) in the set q₀. Optionally, the CSI-RS is a CSI-RS that the UE uses to assess the radio link quality. For example, the periodicity of the CSI-RS is a periodicity associated with a periodic CSI-RS configuration.
A periodicity associated with the first time and/or the second time. For example, the periodicity of the cell DTX. For example, the periodicity of the cell DRX. For example, the periodicity of the cell DTX/DRX. For example, the smaller periodicity of the periodicity of the cell DTX and the periodicity of the cell DRX. Optionally, the periodicity associated with the first time and/or the second time is greater than or equal to a particular length; Optionally, the periodicity associated with the first time and/or the second time is less than or equal to a particular length. For example, the particular length is 80 milliseconds, 160 milliseconds, or 320 milliseconds. For example, the particular length is indicated by the base station.
A periodicity associated with the third time and/or the fourth time. For example, the periodicity of an SBFD operation; For example, a time domain periodicity associated with a second frequency domain resource. For example, a periodicity of a time domain resource where uplink transmission can be performed using the second frequency domain resource. Optionally, the periodicity associated with the third time and/or the fourth time is greater than or equal to a particular length. Optionally, the periodicity associated with the third time and/or the fourth time is less than or equal to a particular length. For example, the particular length is 80 milliseconds, 160 milliseconds, or 320 milliseconds. For example, the particular length is indicated by the base station.
A DRX cycle length or DRX periodicity. For example, a length of the DRX cycle of the UE DRX. Optionally, the DRX cycle length is greater than or equal to a particular length. Optionally, the DRX periodicity length is less than or equal to a particular length. For example, the particular length is 80 milliseconds, 160 milliseconds, or 320 milliseconds. For example, the particular length is indicated by the base station.

Optionally, “when the radio link quality is worse than the threshold” may refer to “when the UE satisfies the sixth condition”. Optionally, “when the radio link quality is worse than the threshold” may refer to “when the radio link quality for the resource configurations in the set q₀ that the UE uses to assess the radio link quality is worse than the Q_{out,LR} threshold”.

An advantage of the above method is that the terminal device can determine the report periodicity of the beam failure detection indication according to the periodicity of the cell DRX/DTX, thereby avoiding the measurement performance loss caused by the mismatch between the indication report periodicity and the DRX/DTX periodicity.

Optionally, if (the UE determines that) a transmission occasion (e.g., a scheduling request (SR) transmission occasion) in an uplink signal or channel (e.g., PUCCH) is within the second time, and the transmission occasion is not associated with (or not used for) the transmission of a particular signal or channel, the UE does not transmit the uplink signal or channel. Optionally, otherwise, the UE transmits the uplink signal or channel. The particular uplink channel and/or signal may include at least one of the following:
SR. For example, a link recovery request (LRR). For example, a positive LRR. For another example, a SR for consistent LBT failure recovery. For example, a positive LRR and a SR for consistent LBT failure recovery.
PUSCH. For example, a PUSCH carrying a beam failure recovery request. For example, a PUSCH carrying a MAC CE of beam failure recovery (BFR).
PRACH transmission. For example, the PRACH transmission related to beam failure recovery.

Optionally, the uplink signal or channel may refer to at least one of PUCCH, PUSCH, and PRACH.

Optionally, the transmission occasion within the second time may refer to that all or part of the transmission occasion is within the second time. Optionally, the transmission occasion within the second time may refer to that at least one time unit (e.g., symbol) of the transmission occasion is within the second time.

Optionally, if (the UE determines that) a transmission occasion (e.g., SR transmission occasion) in an uplink signal or channel (e.g., PUCCH) is within the second time, and the transmission occasion is associated with (or used for) the transmission of a particular signal or channel, the UE transmits the uplink signal or channel. The particular uplink channel and/or signal may include at least one of the following:
SR. For example, a LRR. For example, a positive LRR. For another example, a SR for consistent LBT failure recovery. For another example, a positive LRR and SR for consistent LBT failure recovery.
PUSCH. For example, a PUSCH carrying a BFR MAC CE.
PRACH transmission. For example, a PRACH transmission related to beam failure recovery.

Optionally, the uplink signal or channel may refer to at least one of PUCCH, PUSCH, and PRACH.

Optionally, the transmission occasion within the second time may refer to that all or part of the transmission occasion is within the second time. Optionally, the transmission occasion within the second time may refer to that at least one time unit (e.g., symbol) of the one transmission occasion is within the second time.

In Method VI, details and examples about the first time, the second time, the third time and the fourth time may refer to the description in Method I.

The method has the advantage that the terminal device can transmit a particular uplink signal or channel (e.g., the signal or channel related to beam failure recovery) within the second time (e.g., non-active period(s) of cell DRX). Therefore, in case that the beam failure occurs, the terminal device still can transmit a beam failure request to the base station to perform beam recovery in time, thus guaranteeing the communication quality.

### Method VII

The UE may be configured with a CSI report configuration (e.g., CSI-ReportConfig), where the CSI report configuration may be associated with CSI resource setting(s). Optionally, the CSI resource setting(s) may include CSI resource setting(s) for channel measurement and/or CSI resource setting(s) for interference measurement. Optionally, the CSI resource setting may correspond to/include one or more resource sets. Optionally, the CSI resource setting may correspond to/include at least one of CSI-RS resource(s), CSI-IM resource(s) and SSB resource(s). Optionally, the resource set may include a number of resources. Optionally, the resource set may include/correspond to at least one of CSI-RS resource(s), CSI-IM resource(s) and SSB resource(s). For example, the UE may determine and/or report CSI associated with the CSI report configuration based on measurement of the resources in the CSI resource setting(s) associated with the CSI report configuration.

In some cases, the UE may be configured with a number of serving cells. Optionally, one/each of the serving cells may be configured with cell DTX and/or the cell DTX for one/each of the several serving cells may be activated. For example, among the serving cells configured for the UE, the cell DTX of a part of the cells is activated, while the cell DTX of other cells is not activated. The UE behavior related to CSI measurement/CSI reporting is affected by cell DTX. It is necessary to clarify the resource measurement and/or CSI reporting behavior associated with a CSI report configuration and the cell DTX of which of cell(s) is activated. Note that a cell where the CSI report configuration is located and a cell where CSI resource settings associated with the CSI report configuration is located may be the same or different. For example, the CSI report configuration may include a higher layer parameter (e.g., ‘carrier’) to indicate a cell where the associated CSI resource setting(s) is located. For example, the UE may determine a cell where corresponding measurement resources are located based on the higher layer parameter (e.g., ‘carrier’) that may be included in the CSI report configuration. For example, the UE may determine which cell to perform measurement on based on the high layer parameter (e.g., ‘carrier’) that may be included in the CSI report configuration. For example, if the CSI report configuration does not include a higher layer parameter (e.g., ‘carrier’), the cell where the corresponding/associated CSI resource setting(s) is (are) located is the same as the cell where the CSI report configuration is located. For example, if the CSI report configuration does not include a higher layer parameter (e.g., ‘carrier’), the associated CSI resource setting(s) is (are) in the cell where the CSI report configuration is located. Since whether cell DTX is activated is determined separately for each cell, it is to add restriction in the following method that the corresponding resource measurement and/or CSI reporting behavior of the CSI report configuration is affected by the cell DTX when the cell DTX of the cell where the CSI resource settings associated with the CSI report configuration are located is activated. In the disclosure, the term “CSI” may be used interchangeably with the term “CSI value”. In the disclosure, “the CSI resource setting(s) associated with the CSI report configuration” may be used interchangeably with “the CSI resource setting(s) corresponding to the CSI report configuration”, or “measurement associated with the CSI report configuration”, or “measurement resource(s) associated with the CSI report configuration”, or “resource(s) for channel measurement and/or interference measurement associated with the CSI report configuration”. In the disclosure, “cell DTX is activated” may be used interchangeably with “cell DTX is configured” or “cell DTX is configured and/or activated”.

Optionally, if the higher layer parameter (e.g., timeRestrictionForChannelMeasurements) in the CSI report configuration (e.g., CSI-ReportConfig) is set to “Configured”, the UE determines/derives channel measurements for computing CSI (reported in uplink time slot n) based on (only) occasion of CSI-RS associated with the CSI resource setting (associated with the CSI report configuration). Optionally, the CSI computation may be CQI computation. Optionally, the CSI-RS may be NZP CSI-RS. Optionally, the occasion of CSI-RS may be a CSI-RS transmission occasion. Here, the occasion of CSI-RS refers to/includes/corresponds to at least one of the following:
the most recent occasion of CSI-RS;
occasion of CSI-RS no later than the CSI reference resource;
occasion of CSI-RS within DRX active time;
occasion of CSI-RS within DRX active time when DRX is configured;
occasion of CSI-RS within active period(s) of cell DTX;
if cell DTX is activated on a serving cell with the CSI resource setting associated with the CSI report configuration, occasion of CSI-RS within active period(s) of cell DTX (of the serving cell).

Here, ‘n’ may represent the slot index. Optionally, n≥0. Optionally, the DRX may be UE DRX or C-DRX.

Optionally, if the higher layer parameter (e.g., timeRestrictionForInterferenceMeasurements) in the CSI report configuration (e.g., CSI-ReportConfig) is set to “Configured”, the UE determines/derives interference measurements for computing CSI (reported in uplink time slot n) based on (only) occasion of CSI-IM and/or CSI-RS associated with the CSI resource setting (associated with the CSI report configuration). Optionally, the CSI computation may be CQI computation. Optionally, the CSI-RS may be NZP CSI-RS. Optionally, the occasion of CSI-IM may be a CSI-IM transmission occasion. Optionally, the occasion of CSI-RS may be a CSI-RS transmission occasion. Here, the occasion of CSI-IM and/or CSI-RS refers to/includes/corresponds to at least one of the following:
the most recent occasion of CSI-IM and/or CSI-RS;
occasion of CSI-IM and/or CSI-RS no later than the CSI reference resource;
occasion of CSI-IM and/or CSI-RS within DRX active time;
occasion of CSI-IM and/or CSI-RS within DRX active time when DRX is configured;
occasion of CSI-IM and/or CSI-RS within active period(s) of cell DTX;
if cell DTX is activated on a serving cell with the CSI resource setting associated with the CSI report configuration, occasion of CSI-IM and/or CSI-RS within active period(s) of cell DTX (of the serving cell).

Here, ‘n’ may represent the slot index. Optionally, n≥0. Optionally, the DRX may be UE DRX or C-DRX.

Optionally, for the CSI report configuration (e.g., CSI-ReportConfig) associated with a higher layer parameter related to report quantity (e.g., reportQuantity) comprising at least ‘RI’, and (if) the CSI resource setting associated with the CSI report configuration is on a serving cell with the cell DTX activated, the UE reports a CSI report (only) if at least receiving one CSI-IM and/or CSI-RS occasion; otherwise, the UE drops the CSI report. Optionally, the CSI-IM and/or CSI-RS occasion refers to/corresponds to/includes CSI-IM and/or CSI-RS occasion of (each) periodic CSI-IM and/or CSI-RS resource or semi-persistent CSI-IM and/or CSI-RS resource for channel measurement and/or interference measurement. Optionally, the CSI-RS occasion refers to/corresponds to/includes CSI-RS occasion of (each) periodic CSI-RS resource or semipersistent CSI-RS resource for channel measurement and/or interference measurement. Optionally, the CSI-RS occasion may be CSI-RS transmission occasion. Optionally, the CSI-IM occasion may be CSI-IM transmission occasion. Optionally, CSI-IM and/or CSI-RS occasion refers to/corresponds to/includes at least one of the following:
the most recent CSI-IM and/or CSI-RS occasion;
CSI-IM and/or CSI-RS occasion no later than the CSI reference resource;
CSI-IM and/or CSI-RS occasion within DRX active time;
CSI-IM and/or CSI-RS occasion within DRX active time when DRX is configured;
CSI-IM and/or CSI-RS occasion within active period(s) of cell DTX;
if cell DTX is activated on a serving cell with the CSI resource setting associated with the CSI report configuration, CSI-IM and/or CSI-RS occasion within active period(s) of cell DTX (of the serving cell).

Optionally, the DRX may be UE DRX or C-DRX.

Optionally, if the CSI resource setting associated with the CSI report configuration is on a serving cell with cell DTX activated, the UE does not receive (or is not expected to receive) the periodic CSI-RS and/or a semi-persistent CSI-RS within non-active period(s) of cell DTX (of the serving cell). Optionally, the periodic CSI-RS and/or the semi-persistent CSI-RS configured in the CSI report configuration, and the higher layer parameter (e.g., reportQuantity) associated with the CSI report configuration comprising at least ‘RI’.

Optionally, if the cell DTX is activated for a serving cell and the CSI resource setting associated with the CSI report configuration is on the serving cell, for the higher layer parameter related to report quantity (e.g., reportQuantity) with the CSI report configuration including at least ‘RI’, the most recent CSI measurement occasion (associated with the CSI report configuration) of semi-persistent CSI-RS resource or periodic CSI-RS resource occurs in active periods of cell DTX.

In this method, restriction is added by condition that when the cell DTX of a serving cell (or a serving cell where measurement resources are located) associated with/corresponding to the CSI report configuration, the corresponding measurement/reporting for the CSI report configuration is based on the cell DTX, thereby clarifying the UE behavior associated with the CSI report configuration and improving the reliability of the communication system.

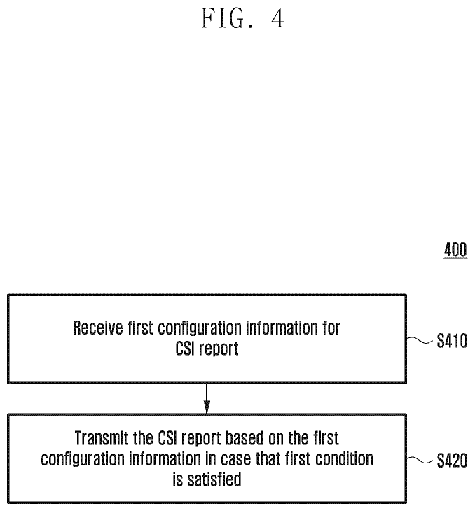

FIG. 4 shows a flow chart of a method 400 performed by a terminal according to some embodiments of the disclosure.

Referring to FIG. 4, in the operation S410, the terminal receives first configuration information for a channel state information (CSI) report. For example, the configuration information may be received from a base station via higher layer signaling (e.g., a RRC message).

Continuing to refer to FIG. 4, in the operation S420, the terminal transmits a CSI report based on the first configuration information in case that the first condition is satisfied. The first condition is related to one or more of: a time associated with cell discontinuous transmission (DTX), a time associated with cell discontinuous reception (DRX), or a time associated with subband full duplex (SBFD).

In some implementations, the operations S410 and/or S420 may be performed based on methods described according to various embodiments of the disclosure (e.g., various methods described above, such as Methods I to VI).

In some implementations, one or more of the operations S410 and/or S420 may be omitted in the method 400, or additional operations may be included, for example, the operations performed by the terminal (e.g., UE) and described according to various embodiments of the disclosure (e.g., various methods described above, such as Methods I to VI).

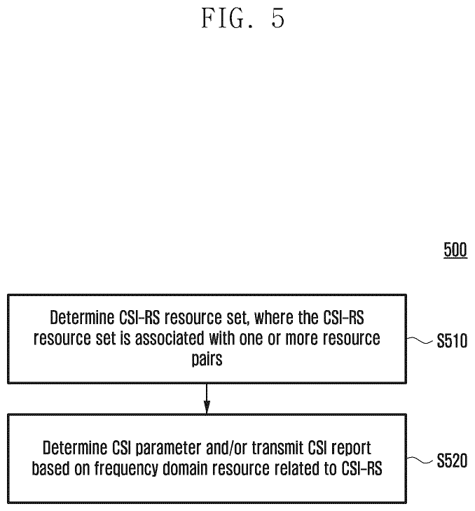

FIG. 5 shows a flow chart of a method 500 performed by a terminal according to some embodiments of the disclosure.

Referring to FIG. 5, in the operation S510, the terminal determines a channel state information-reference signal (CSI-RS) resource set, where the CSI-RS resource set is associated with one or more resource pairs.

Continue to refer to FIG. 5, in the operation S520, the terminal determines a CSI-RS parameter and/or transmits a CSI report based on a frequency domain resource related to the CSI-RS, where the CSI report includes the CSI parameter, and the CSI parameter is determined based on the frequency domain resource related to the CSI-RS. The frequency domain resource related to the CSI-RS is determined based on a frequency domain resource of a resource pair associated with the CSI report among the one or more resource pairs.

In some implementations, the operations S510 and/or S520 may be performed based on methods described according to various embodiments of the disclosure (e.g., various methods described above, such as Methods I to VI).

In some implementations, one or more in the operations S510 and/or S520 may be omitted in the method 500, or additional operations may be included, for example, the operations performed by the terminal (e.g., UE) and described according to various embodiments of the disclosure (e.g., various methods described above, such as Methods I to VI).

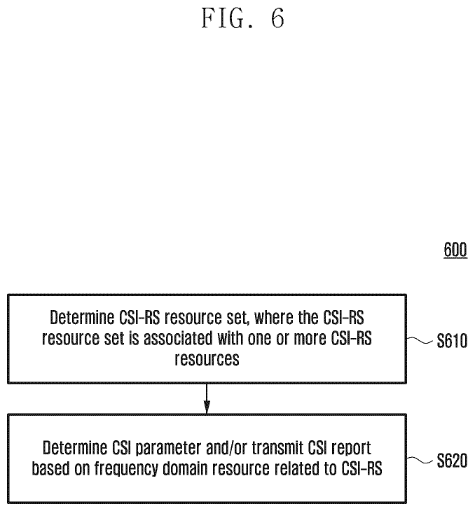

FIG. 6 shows a flow chart of a method 600 performed by a terminal according to some embodiments of the disclosure.

Referring to FIG. 6, in the operation S610, the terminal determines a channel state information-reference signal (CSI-RS) resource set, where the CSI-RS resource set is associated with one or more CSI-RS resources.

Continue to refer to FIG. 6, in the operation S620, the terminal determines a CSI parameter and/or transmits a CSI report based on a frequency domain resource related to the CSI-RS, where the CSI report includes the determined CSI parameter. In case that subband full duplex (SBFD) is configured, the frequency domain resource related to the CSI-RS is determined based on one or more of: a frequency domain resource of the CSI-RS resource associated with the CSI report in the one or more CSI-RS resources, or a frequency domain resource for downlink among the frequency domain resource associated with the SBFD.

In some implementations, the operations S610 and/or S620 may be performed based on the methods described according to various embodiments of the disclosure (e.g., various methods described above, such as Methods I to VI).

In some implementations, one or more of the operations S610 and/or S620 may be omitted in the method 600, or additional operations may be included, for example, the operations performed by the terminal (e.g., UE) and described according to various embodiments of the disclosure (e.g., various methods described above, such as Methods I to VI).

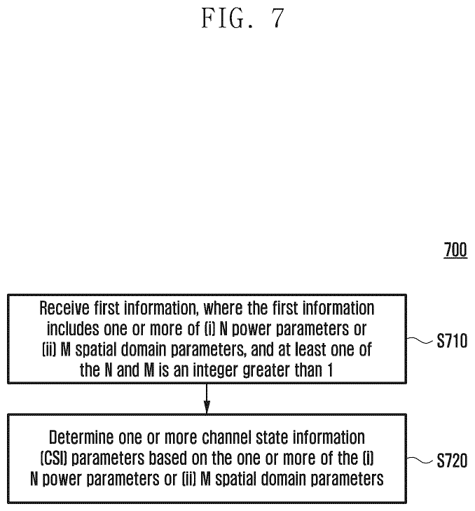

FIG. 7 shows a flow chart of a method 700 performed by a terminal according to some embodiments of the disclosure.

Referring to FIG. 7, in the operation S710, the terminal receives first information, where the first information includes one or more of (i) N power parameters or (ii) M spatial domain parameters, and at least one of M and N is an integer greater than 1.

Continue to refer to FIG. 7, in the operation S720, the terminal determines one or more channel state information (CSI) parameters based on one or more of (i) the N power parameters or (ii) the M spatial domain parameters.

In some implementations, the operations S710 and/or S720 may be performed based on the methods described according to various embodiments of the disclosure (e.g., various methods described above, such as Methods I to IV).

In some implementations, one or more of the operations S710 and/or S720 may be omitted in the method 700, or additional operations may be included, for example, the operations performed by the terminal (e.g., UE) and described according to various embodiments of the disclosure (e.g., various methods described above, such as Methods I to IV).

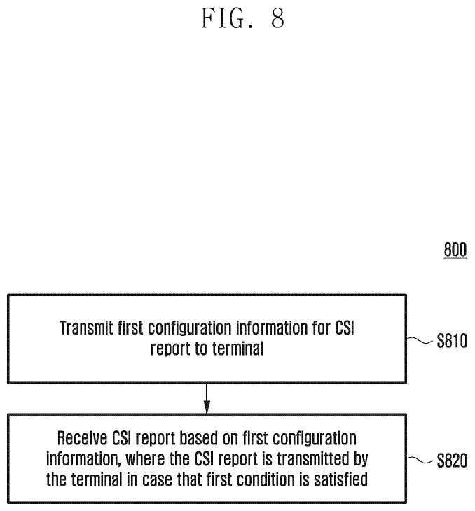

FIG. 8 is a flow chart of a method performed by a base station according to some embodiments of the disclosure.

Referring to FIG. 8, in the operation S810, the base station receives first configuration information for a channel state information (CSI) report.

Continue to refer to FIG. 8, in the operation S820, the base station receives a CSI report based on the first configuration information, where the CSI report is transmitted by a terminal in case that a first condition is satisfied. The first condition is related to one or more of: a time associated with cell discontinuous transmission (DTX), a time associated with cell discontinuous reception (DRX), or a time associated with subband full duplex (SBFD).

In some implementations, the operations S810 and/or S820 may be performed based on methods described according to various embodiments of the disclosure (e.g., various methods described above, such as Methods I to VI).

In some implementations, one or more of the operations S810 and/or S820 may be omitted in the method 800, or additional operations may be included, for example, the operations performed by the terminal (e.g., UE) and described according to various embodiments of the disclosure (e.g., various methods described above, such as Methods I to VI).

According to an embodiment of the disclosure, a method performed by a terminal in a wireless communication system is provided.

According to an embodiment of the disclosure, the method including receiving first configuration information for a channel state information (CSI) report; and in case that a first condition is satisfied, transmitting the CSI report based on the first configuration information.

According to an embodiment of the disclosure, the first condition is related to one or more of: a time associated with cell discontinuous transmission (DTX), a time associated with cell discontinuous reception (DRX), or a time associated with subband full duplex (SBFD).

According to an embodiment of the disclosure, the first condition includes one or more of the following: one or more of at least one channel state information-reference signal (CSI-RS) transmission occasion or at least one channel state information-interference measurement (CSI-IM) occasion in the time associated with the cell DTX are received; one or more of at least one CSI-RS transmission occasion or at least one CSI-IM occasion in the time associated with the SBFD are received; one or more of at least one CSI-RS transmission occasion or at least one CSI-IM occasion outside the time associated with the SBFD are received; one or more of at least one CSI-RS transmission occasion or at least one CSI-IM occasion in the time associated with the cell DTX are received, wherein a frequency domain resource associated with at least one of the one or more of the at least one CSI-RS transmission occasion or the at least one CSI-IM occasion is located in frequency domain resources associated with the cell DTX; one or more of at least one CSI-RS transmission occasion or at least one CSI-IM occasion in the time associated with the SBFD are received, wherein a frequency domain resource associated with at least one of the one or more of the at least one CSI-RS transmission occasion or the at least one CSI-IM occasion is located in a frequency domain resource for downlink among frequency domain resources associated with the SBFD; and one or more of at least one CSI-RS transmission occasion or at least one CSI-IM occasion outside the time associated with the SBFD are received.

According to an embodiment of the disclosure, a frequency domain source associated with at least one of the one or more of the at least one CSI-RS transmission occasion or the at least one CSI-IM occasion is located in a frequency domain resource for downlink among frequency domain resources associated with the SBFD.

According to an embodiment of the disclosure, the first condition includes one or more of the following: the first configuration information includes a report quantity parameter that indicates at least one report quantity of the CSI report; second configuration information associated with the cell DRX is received; a transmission occasion of the CSI report is in the time associated with the cell DRX; prior to receiving a first downlink control information (DCI) format for triggering the CSI report, a second DCI format for determining the time associated with the cell DRX is received; the CSI report is one or more of a periodic CSI report, a semi-persistent CSI report, or an aperiodic CSI report; the CSI report is carried by a physical uplink shared channel (PUSCH), wherein the PUSCH includes a transport block (TB); the CSI report is carried by a PUSCH, wherein the PUSCH does not include a TB; or the CSI report is carried by a physical uplink control channel (PUCCH).

According to an embodiment of the disclosure, the first condition further includes that: the at least one report quantity is one or more of the following combinations: a CSI-RS resource indicator (CRI), a rank indicator (RI), a precoding matrix indicator (PMI), and a channel quality indicator (CQI); the CRI, the RI, a layer indicator (LI), the PMI, and the CQI; the CRI, the RI, and a codebook parameter; the CRI, the RI, the codebook parameter, and the CQI; or the CRI, the RI, and the CQI.

According to an embodiment of the disclosure, a method performed by a terminal in a wireless communication system is provided.

According to an embodiment of the disclosure, the method includes determining a channel state information-reference signal (CSI-RS) resource set, wherein the CSI-RS resource set is associated with one or more resource pairs; and performing one or more of: determining a CSI parameter based on a frequency domain resource related to a CSI-RS; or transmitting a CSI report, wherein the CSI report includes the CSI parameter determined based on the frequency domain resource related to the CSI-RS.

According to an embodiment of the disclosure, the frequency domain resource related to the CSI-RS is determined based on a frequency domain resource of a resource pair associated with the CSI report among the one or more resource pairs.

According to an embodiment of the disclosure, the frequency domain resource related to the CSI-RS is determined based on a union or an intersection of frequency domain resources of two resources of the resource pair associated with the CSI report among the one or more resource pairs.

According to an embodiment of the disclosure, in case that subband full duplex (SBFD) is configured, the frequency domain resource related to the CSI-RS is further determined based on a frequency domain resource for downlink among frequency domain resources associated with the SBFD.

According to an embodiment of the disclosure, in case that SBFD is configured: a CSI reference resource for the CSI report and/or a downlink control information (DCI) format for triggering the CSI report are/is within a time associated with the SBFD; or the CSI reference resource for the CSI report and/or the DCI format for triggering the CSI report are/is outside the time associated with the SBFD.

According to an embodiment of the disclosure, the transmitting the CSI report includes transmitting the CSI report in case that a first condition is satisfied.

According to an embodiment of the disclosure, the first condition includes one or more of the following: first configuration information is received, wherein the first configuration information includes a report quantity parameter that indicates a report quantity of the CSI report; one or more of at least one CSI-RS transmission occasion or at least one channel state information-interference measurement (CSI-IM) occasion in the time associated with the SBFD are received; one or more of at least one CSI-RS transmission occasion or at least one CSI-IM occasion outside the time associated with the SBFD are received; one or more of at least one CSI-RS transmission occasion or at least one CSI-IM occasion in the time associated with the SBFD are received, wherein a frequency domain resource associated with at least one of the one or more of the at least one CSI-RS transmission occasion or the at least one CSI-IM occasion is located in a frequency domain resource for downlink among frequency domain resources associated with the SBFD; one or more of at least one CSI-RS transmission occasion or at least one CSI-IM occasion outside the time associated with the SBFD are received.

According to an embodiment of the disclosure, a frequency domain source associated with at least one of the one or more of the at least one CSI-RS transmission occasion or the at least one CSI-IM occasion is located in a frequency domain resource for downlink among frequency domain resources associated with the SBFD; the CSI report is one or more of a periodic CSI report, a semi-persistent CSI report, or an aperiodic CSI report;

the CSI report is carried by a physical uplink shared channel (PUSCH), wherein the PUSCH includes a transport block (TB); the CSI report is carried by a PUSCH, wherein the PUSCH does not include a TB; or the CSI report is carried by a physical uplink control channel (PUCCH).

According to an embodiment of the disclosure, the first condition further includes: the report quantity is one or more of the following combinations: a CSI-RS resource indicator (CRI), a rank indicator (RI), a precoding matrix indicator (PMI), and a channel quality indicator (CQI); the CRI, the RI, a layer indicator (LI), the PMI, and the CQI; the CRI, the RI and a single wideband indication; the CRI, the RI, the single wideband indication, and the CQI; or the CRI, the RI, and the CQI.

According to an embodiment of the disclosure, a method performed by a terminal in a wireless communication system is provided.

According to an embodiment of the disclosure, the method includes: determining a channel state information-reference signal (CSI-RS) resource set, wherein the CSI-RS resource set is associated with one or more CSI-RS resources; and performing one or more of: determining a CSI parameter based on a frequency domain resource related to a CSI-RS; or transmitting a CSI report, wherein the CSI report includes the determined CSI parameter; in case that subband full duplex (SBFD) is configured, the frequency domain resource related to the CSI-RS is determined based on one or more of: a frequency domain resource of a CSI-RS resource associated with the CSI report among the one or more CSI-RS resources; or a frequency domain resource for downlink among frequency domain resources associated with the SBFD.

According to an embodiment of the disclosure, wherein: a CSI reference resource for the CSI report is within a time associated with the SBFD; or the CSI reference resource for the CSI report is outside the time associated with the SBFD.

According to an embodiment of the disclosure, the transmitting the CSI report includes transmitting the CSI report in case that a first condition is satisfied, wherein the first condition includes one or more of: first configuration information is received, wherein the first configuration information includes a report quantity parameter that indicates a report quantity of the CSI report; one or more of at least one CSI-RS transmission occasion or at least one channel state information-interference measurement (CSI-IM) occasion in the time associated with the SBFD are received; one or more of at least one CSI-RS transmission occasion or at least one CSI-IM occasion outside the time associated with the SBFD are received; one or more of at least one CSI-RS transmission occasion or at least one CSI-IM occasion in the time associated with the SBFD are received, wherein a frequency domain resource associated with at least one of the one or more of the at least one CSI-RS transmission occasion or the at least one CSI-IM occasion is located in a frequency domain resource for downlink among frequency domain resources associated with the SBFD; one or more of at least one CSI-RS transmission occasion or at least one CSI-IM occasion outside the time associated with the SBFD are received, wherein a frequency domain resource associated with at least one of the one or more of the at least one CSI-RS transmission occasion or the at least one CSI-IM occasion is located in a frequency domain resource for downlink among frequency domain resources associated with the SBFD; the CSI report is one or more of a periodic CSI report, a semi-persistent CSI report, or an aperiodic CSI report; the CSI report is carried by a physical uplink shared channel (PUSCH), wherein the PUSCH includes a transport block (TB); the CSI report is carried by a PUSCH, wherein the PUSCH does not include a TB; or the CSI report is carried by a physical uplink control channel (PUCCH).

According to an embodiment of the disclosure, the first condition includes: the report quantity is one or more of the following combinations: a CSI-RS resource indicator (CRI), a rank indicator (RI), a precoding matrix indicator (PMI), and a channel quality indicator (CQI); the CRI, the RI, a layer indicator (LI), the PMI, and the CQI; the CRI, the RI, and a single wideband indication; the CRI, the RI, the single wideband indication, and the CQI; or the CRI, the RI, and the CQI.

According to an embodiment of the disclosure, a method performed by a terminal in a wireless communication system is provided.

According to an embodiment of the disclosure, the method includes: receiving first information, wherein the first information includes one or more of (i) N power parameters, or (ii) M spatial domain parameters, and at least one of the N and M is an integer greater than 1; and determining one or more channel state information (CSI) parameters based on one or more of (i) the N power parameters or (ii) the M spatial domain parameters.

According to an embodiment of the disclosure, the determining the CSI parameter based on one or more of (i) the N power parameters or (ii) the M spatial domain parameters includes one or more of: determining the one or more CSI parameters based on the N power parameters; determining the one or more CSI parameters based on the M spatial domain parameters; determining the one or more CSI parameters based on the N power parameters and the M spatial domain parameters; or determining the one or more CSI parameters based on a plurality of combinations of the power parameters and the spatial domain parameters, wherein each of the combinations includes a power parameter from the N power parameters and a spatial domain parameter from the M spatial domain parameters; or determining the one or more CSI parameters based on N {power parameter, spatial domain parameter} pairs, the first information including the N {power parameter, spatial domain parameter} pairs, wherein N is equal to M.

According to an embodiment of the disclosure, the number of the plurality of combinations is N*M.

According to an embodiment of the disclosure, the method further includes receiving second information that indicates one or more of: a first subset of the N power parameters included in the first information; a second subset of the M spatial domain parameters included in the first information; a third subset of the plurality of combinations of the power parameters and the spatial domain parameters included in the first information, wherein each of the combinations includes a power parameter from the N power parameters and a spatial domain parameter from the M spatial domain parameters; or a fourth subset of the N {power parameter, spatial domain parameter} pairs included in the first information, wherein N is equal to M,

According to an embodiment of the disclosure, the determining the one or more CSI parameters based on (i) the N power parameters and/or (ii) the M spatial domain parameters includes: determining the one or more CSI parameters based on a subset indicated by the second information; or determining the one or more CSI parameters based on power parameters and/or spatial domain parameters other than the subset indicated by the second information.

According to an embodiment of the disclosure, the indicated subset includes at least one of the first subset, the second subset, the third subset, and the fourth subset.

According to an embodiment of the disclosure, the method further includes determining a number of CSI reports to be updated based on one or more of (i) the N power parameters or (ii) the M spatial domain parameters.

According to an embodiment of the disclosure, a method performed by a terminal in a communication system is provided.

According to an embodiment of the disclosure, the method includes receiving a first configuration of a channel state information (CSI) report; and transmitting, based on the first configuration, the CSI report on a serving cell with cell discontinuous transmission (DTX) being activated in case that a predefined condition is satisfied.

According to an embodiment of the disclosure, the predefined condition includes receiving at least one channel state information reference signal (CSI-RS) in an active period of the cell DTX.

According to an embodiment of the disclosure, the method further includes dropping the CSI report in case that the predefined condition is not satisfied.

According to an embodiment of the disclosure, the at least one CSI-RS corresponds to at least one CSI-RS transmission occasion of each CSI-RS resource for at least one of channel measurement or interference measurement in the active period of cell DTX no later than a CSI reference resource.

According to an embodiment of the disclosure, the first configuration includes a report quantity indicating one of: a combination of a CSI-RS resource indicator (CRI), a rank indicator (RI), a precoding matrix indicator (PMI) and a channel quality indicator (CQI); a combination of the CRI, the RI, and a codebook parameter i1; a combination of the CRI, the RI, the codebook parameter i1 and the CQI; a combination of the CRI, the RI and the CQI; or a combination of the CRI, the RI, a layer indicator (LI), the PMI, and the CQI.

According to an embodiment of the disclosure, the method further includes receiving a second configuration of the cell DTX.

According to an embodiment of the disclosure, a downlink signal is not received during a non-active period of the cell DTX.

According to an embodiment of the disclosure, the downlink signal includes a CSI-RS.

According to an embodiment of the disclosure, the active period and the non-active period are identified based on the second configuration.

According to an embodiment of the disclosure, a method performed by a base station in a communication system is provided.

According to an embodiment of the disclosure, the method includes: transmitting a first configuration of a channel state information (CSI) report on a serving cell with cell discontinuous transmission (DTX) being activated; and receiving the CSI report in case that a predefined condition is satisfied.

According to an embodiment of the disclosure, the predefined condition is associated with transmitting at least one channel state information reference signal (CSI-RS) in an active period of the cell DTX.

According to an embodiment of the disclosure, the at least one CSI-RS corresponds to at least one CSI-RS transmission occasion of each CSI-RS resource for at least one of channel measurement or interference measurement in the active period of cell DTX no later than a CSI reference resource.

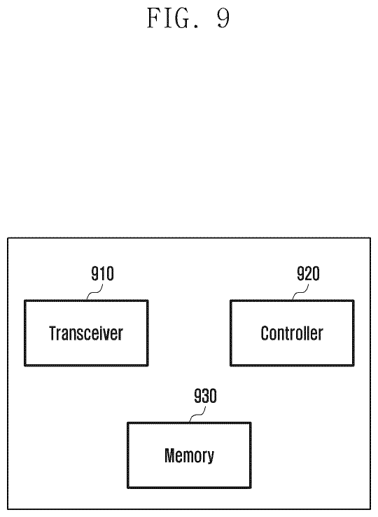

FIG. 9 is a block diagram of a terminal according to some embodiments of the disclosure.

Referring to FIG. 9, the terminal includes a transceiver 910, a controller 920, and a memory 930. The controller 920 may refer to a circuit, an application specific integrated circuit (ASIC), or at least one processor. The transceiver 910, the controller 920 and the memory 930 are configured to execute the operations of the terminal above. Although the transceiver 910, the controller 920 and the memory 930 are shown as separate entities, the transceiver 910, the controller 920 and the memory 930 may be implemented as a single entity, such as a single chip. Or, the transceiver 910, the controller 920 and the memory 930 may be electrically connected or coupled to one another.

The transceiver 910 may transmit a signal to other network entities (e.g., a base station) and receives a signal from other network entities.

The controller 920 may control the terminal to execute the function of one of the above embodiments (such as Methods I to VI). For example, the controller 920 controls the transceiver 910 and/or the memory 930 to execute the operations related to the CSI report according to various embodiments of the disclosure.

In an implementation, the operation of the terminal may be implemented using the memory 930 that stores corresponding program codes. Specifically, the terminal may be equipped with the memory 930 to store the program codes for achieving a desired operation. To execute the desired operation, the controller 920 may read and execute the program code stored in the memory 930 using at least one processor or a central processing unit (CPU).

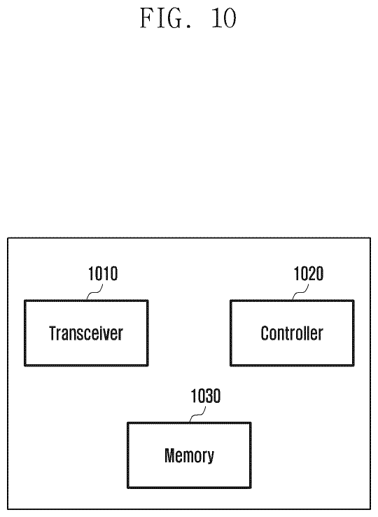

FIG. 10 is a block diagram of a base station according to some embodiments of the disclosure.

Referring to FIG. 10, the terminal includes a transceiver 1010, a controller 1020, and a memory 1030. The controller 1020 may refer to a circuit, an application specific integrated circuit (ASIC), or at least one processor. The transceiver 1010, the controller 1020, and the memory 1030 are configured to execute the operations of the base station above. Although the transceiver 1010, the controller 1020 and the memory 1030 are shown as separate entities, the transceiver 1010, the controller 1020 and the memory 1030 may be implemented as a single entity, such as a single chip. Or, the transceiver 1010, the controller 1020 and the memory 1030 may be electrically connected or coupled to one another.

The transceiver 1010 may transmit a signal to other network entities (e.g., a terminal) and receives a signal from other network entities.

The controller 1020 may control the base station to execute the function of one of the above embodiments (such as Methods I to VI). For example, the controller 1020 controls the transceiver 1010 and/or the memory 1030 to execute the operations related to the CSI report of the terminal according to various embodiments of the disclosure.

In an implementation, the operation of the base station may be implemented using the memory 1030 that stores corresponding program codes. Specifically, the base station may be equipped with a memory 1030 to store program codes for achieving a desired operation. To execute the desired operation, the controller 1020 may read and execute the program codes stored in the memory 1030 using at least one processor or a central processing unit (CPU).

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above description is only an exemplary implementation of the present invention, and is not intended to limit the scope of protection of the present invention, which is determined by the appended claims.

1. A method performed by a terminal in a communication system, the method comprising:
receiving a first configuration of a channel state information (CSI) report; and
transmitting, based on the first configuration, the CSI report on a serving cell with cell discontinuous transmission (DTX) being activated in case that a predefined condition is satisfied,
wherein the predefined condition includes receiving at least one channel state information reference signal (CSI-RS) in an active period of the cell DTX.

2. The method of claim 1, further comprising dropping the CSI report in case that the predefined condition is not satisfied.

3. The method of claim 1, wherein the at least one CSI-RS corresponds to at least one CSI-RS transmission occasion of each CSI-RS resource for at least one of channel measurement or interference measurement in the active period of cell DTX no later than a CSI reference resource.

4. The method of claim 1, wherein the first configuration includes a report quantity indicating one of:
a combination of a CSI-RS resource indicator (CRI), a rank indicator (RI), a precoding matrix indicator (PMI) and a channel quality indicator (CQI);
a combination of the CRI, the RI, and a codebook parameter i1;
a combination of the CRI, the RI, the codebook parameter i1 and the CQI;
a combination of the CRI, the RI and the CQI; or
a combination of the CRI, the RI, a layer indicator (LI), the PMI, and the CQI.

5. The method of claim 1, further comprising receiving a second configuration of the cell DTX,
wherein a downlink signal is not received during a non-active period of the cell DTX, wherein the downlink signal includes a CSI-RS, and
wherein the active period and the non-active period are identified based on the second configuration.

6. A terminal in a communication system, the terminal comprising:
a transceiver; and
a processor coupled with the transceiver and configured to:
receive a first configuration of a channel state information (CSI) report; and
transmit, based on the first configuration, the CSI report on a serving cell with cell discontinuous transmission (DTX) being activated in case that a predefined condition is satisfied,
wherein the predefined condition includes receiving at least one channel state information reference signal (CSI-RS) in an active period of the cell DTX.

7. The terminal of claim 6, wherein the processor is further configured to drop the CSI report in case that the predefined condition is not satisfied.

8. The method of claim 6, wherein the at least one CSI-RS corresponds to at least one CSI-RS transmission occasion of each CSI-RS resource for at least one of channel measurement or interference measurement in the active period of cell DTX no later than a CSI reference resource.

9. The method of claim 6, wherein the first configuration includes a report quantity indicating one of:
a combination of a CSI-RS resource indicator (CRI), a rank indicator (RI), a precoding matrix indicator (PMI) and a channel quality indicator (CQI);
a combination of the CRI, the RI, and a codebook parameter i1;
a combination of the CRI, the RI, the codebook parameter i1 and the CQI;
a combination of the CRI, the RI and the CQI; or
a combination of the CRI, the RI, a layer indicator (LI), the PMI, and the CQI.

10. The method of claim 6, wherein the processor is further configured to receive a second configuration of the cell DTX,
wherein a downlink signal is not received during a non-active period of the cell DTX, wherein the downlink signal includes a CSI-RS, and
wherein the active period and the non-active period are identified based on the second configuration.

11. A method performed by a base station in a communication system, the method comprising:
transmitting a first configuration of a channel state information (CSI) report; and
receiving the CSI report on a serving cell with cell discontinuous transmission (DTX) being activated in case that a predefined condition is satisfied,
wherein the predefined condition is associated with transmitting at least one channel state information reference signal (CSI-RS) in an active period of the cell DTX.

12. The method of claim 11, wherein the at least one CSI-RS corresponds to at least one CSI-RS transmission occasion of each CSI-RS resource for at least one of channel measurement or interference measurement in the active period of cell DTX no later than a CSI reference resource.

13. A base station in a communication system, the base station comprising:
a transceiver; and
a processor coupled with the transceiver and configured to:
transmit a first configuration of a channel state information (CSI) report; and
receive the CSI report on a serving cell with cell discontinuous transmission (DTX) being activated in case that a predefined condition is satisfied,
wherein the predefined condition is associated with transmitting at least one channel state information reference signal (CSI-RS) in an active period of the cell DTX.

14. The base station of claim 13, wherein the at least one CSI-RS corresponds to at least one CSI-RS transmission occasion of each CSI-RS resource for at least one of channel measurement or interference measurement in the active period of cell DTX no later than a CSI reference resource.

15. The base station of claim 13, wherein the processor is further configured to transmit a second configuration of the cell DTX,
wherein a downlink signal is not transmitted during a non-active period of the cell DTX, wherein the downlink signal includes a CSI-RS, and
wherein the active period and the non-active period are based on the second configuration.
